(19) United States
(12) Patent Application Publication
(10) Pub. No.: US 2013/0179290 A1
(43) Pub. Date: Jul. 11, 2013

(54) WIRELESS JUKEBOX ORDERING AND ADMINISTRATION APPLICATION WITH RESTAURANT AND ADMINISTRATIVE SUPPORT

(71) Applicant: Jonathan W. Selley, Beverly, MA (US)

(72) Inventor: Jonathan W. Selley, Beverly, MA (US)

(21) Appl. No.: 13/602,766

(22) Filed: Sep. 4, 2012

Related U.S. Application Data
(63) Continuation of application No. 12/881,847, filed on Sep. 14, 2010.
(60) Provisional application No. 61/318,167, filed on Mar. 26, 2010.

(51) Int. Cl. H04L 29/08; G06Q 20/32; G06F 21/60

(52) U.S. Cl. CPC H04L 67/32; G06Q 20/32; G06F 21/60
USPC 705/26.3; 705/40; 709/219; 726/30

(57) ABSTRACT

A systems and methods providing queued content selection and delivery to geographically distributed venues and wireless devices and providing ancillary information and services related to such venues, including provisioning, management, and tracking of media selections and information provision.

### CROSS-REFERENCE TO RELATED APPLICATIONS

This application claims the priority of U.S. Provisional App. No. 61/318,167, entitled “Jukebox requests via smartphone” filed Mar. 26, 2010, the entirety of which is incorporated herein by reference.

### FIELD OF THE INVENTION

The present invention relates generally to systems and methods for providing content and, more particularly, to systems and methods for providing queued content selection and delivery to geographically distributed venues and providing ancillary information and services related to such venues, including provisioning, management, and tracking of media selections and information provision.

### BACKGROUND OF THE INVENTION

A traditional jukebox is a large machine that sits in a fixed location where customers insert dollar bills to pay for music requests from the catalog of album choices that resides on that machine. This remains the model even today. For example, a company named TouchTunes currently designs, manufactures, markets and distributes touch screen jukebox systems for commercial establishments, and in particular for restaurants and bars. TouchTunes jukeboxes are refrigerator-sized vending machines that sell music by accepting coins or paper money directly into the machine; some accept credit cards, but the interface is often disabled due to the administrative and monetary costs involved in maintaining individual accounts.

Such modern touch-screen jukeboxes have several limitations. They do not allow streaming of music over the internet. Currently available digital touch screen jukeboxes store music locally on a hard drive or static media such as a CD-ROM. To the extent they are connected to the internet, current digital touch screen jukeboxes download and store music files locally on a hard drive upon request from the user, and they generally charge a fee from a user standing in front of the jukebox to do so. In other words, songs which are stored locally are available for one price, while songs available from a remote catalog are available for a higher price.

An advantage of a jukebox is that it generates revenue for establishments by allowing customers to choose their own background music. However, current jukeboxes are disadvantageously large, individually managed, generally cash-based vending machines with relatively static media choices with only a single user interface per site. This leads to their under utilization by patrons of establishments and also leads to high costs associated with collection of revenue from the machines, which much be emptied of currency by hand.

### SUMMARY OF THE INVENTION

According to one embodiment of the present invention, a method of providing content delivery includes providing a database of content accessible via a network, allowing selection of content by any subscriber device on the network, determining a venue where the content should be delivered, and providing an indication that the selected content is in a queue to be presented at the venue. In another embodiment of the present invention, the queue is provided to subscriber devices for display to respective users of the devices. In another embodiment, the queue for each venue is provided to a plurality of subscriber devices of users that are present at the venue or specify the respective venue. In another embodiment, the queue is provided to a plurality of additional devices of users that specify the venue. In another embodiment a plurality of venues are available for selection. In one embodiment of the present invention, the queued content for presentation at the venue is played at the venue in the order of the queue.

According to one embodiment of the present invention, playing comprises streaming the content to a host at the venue. In another embodiment of the present invention playing comprises transmitting content as a download to a host at the venue. In one embodiment the downloaded content is protected by DRM with an expiration time. In one embodiment determining a venue further comprises searching a database of venues for criteria selected by a user. In a further embodiment, determining a venue further comprises providing for selection a plurality of venues with the criteria.

According to one embodiment of the present invention, a method of providing user selectable content for a venue, comprises receiving at a mobile device a list of content available from a content subscription server for playing, selecting content from the list, assigning a venue to the selection, transmitting the selection and venue to the content subscription server, and receiving a queue for the venue, the queue including selections queued for playing at the venue. In one embodiment of the present invention the mobile device of the user prompts the user for payment for playing the selection at the venue and the user effectuates payment using the device. In one embodiment the selection from the user is placed into the queue for the venue after payment is made. In one embodiment of the present invention payment is in the amount of a highest bid made in an auction.

In one embodiment of the present invention, a menu for the venue is received at the device. In one embodiment the menu is an hypertext markup language file that allows the user to obtain menu information and other information about the selected venue.

According to one embodiment of the present invention, a method of delivering user requested content at a venue, comprises receiving at a computer coupled to a network user selected content in a queue, playing the content from the queue over an audio system in the venue, wherein the queue is created by a remote content subscription server and the contents of the queue embody selections by mobile devices associated with the venue by users of those devices. In one embodiment, content is only placed into the queue after users of the mobile devices have selected the content and made electronic payment for the selected content using the mobile devices. In another embodiment of the present invention a plurality of mobile devices at each venue may be used to alter the queue. In another embodiment, the queue is provided to a menu application on a device for display.

According to one embodiment of the present invention, a method for creating a menu for a venue comprises accessing a remote content subscription server over a network, configuring a theme for display of menu items, and adding one or more items to the menu. In one embodiment of the present invention the method further comprises adding information about the venue. In one embodiment the information includes the address of the venue.

According to one embodiment of the present invention, a system providing content delivery to a venue, comprises a database including content, subscriber and venue information and a server coupled to the database and accessible over a network; wherein the server allows selection of content via a device on the network, determines a selected venue among a plurality of venues where the content should be delivered, and maintains separate queues of selected content, each separate queue including selected content to be presented at each corresponding venue. In another embodiment, the server transmits one of the queues via the network to each one of a plurality of mobile devices that has selected one of the venues corresponding to the queue. In a further embodiment, the server is capable of communication via the network with a plurality of devices to permit selection of the content for each queue from any of the plurality of devices. In an additional embodiment of the invention, the server streams the content in one of the queues to a host at the corresponding venue. In a further embodiment, the server transmits the content in one of the queues as a DRM protected download to a host at the corresponding venue. In yet a further embodiment, the DRM protection includes an expiration time.

According to one embodiment of the present invention, a computer program for providing content at venues, the computer program product comprises computer program instructions stored on a computer usable medium, the computer program instructions including providing logic for causing a computer to provide access to a database including content, subscriber information and venue information, selecting logic for causing the computer to allow purchase of content from a subscriber's device via a network, determining logic for causing the computer to determine a selected venue among a plurality of venues where the purchased content should be delivered, and queuing logic for causing the computer to maintain a separate queue of selected content for presentation at each corresponding venue.

In a further embodiment of the invention, the computer program logic includes transmission logic for causing the computer to transmit one of the queues via the network to each one of a plurality of mobile devices that has selected one of the venues corresponding to the queue. In a yet further embodiment, the computer program logic includes communication logic for causing the computer to communicate via the network with a plurality of devices to permit selection of the content for each queue from any of the plurality of devices.

In an additional embodiment, the computer program logic includes streaming logic for causing the computer to stream the content in one of the queues to a host at the corresponding venue. In an additional embodiment, the computer program logic includes transmit logic for causing the computer to transmit the content in one of the queues as a DRM protected download to a host at the corresponding venue. In a further embodiment the DRM protection includes an expiration time.

According to one embodiment of the present invention, a computer program product for enabling content selection and delivery to various venues, the computer program product comprises computer program instructions stored on a computer usable medium, the computer program instructions including selection logic for causing a device to allow user selection of a venue and content, and queue logic for causing the device to display a queue of content, including the user's selection, that will be presented at the venue. In a further embodiment the selection logic further comprises location logic that causes the device to identify its location and facilitate the user's selection of the venue based on the identified location. In an embodiment of the invention the device is a wireless mobile device.

In an alternative embodiment of the invention the computer program logic includes network logic for causing the wireless mobile device to transmit the selections via a network to a remote server that facilitates playing content at the selected venue. In a further embodiment the computer program logic includes payment logic for causing the wireless mobile device to complete a purchase transaction for purchasing the content selection to be played at the selected venue.

### BRIEF DESCRIPTION OF THE DRAWINGS

FIG. 1 depicts an exemplary system according to an embodiment of the present invention.

FIG. 2 depicts exemplary Host systems according to an embodiment of the present invention.

FIG. 3 depicts an exemplary database structure, according to an embodiment of the present invention.

FIG. 4 depicts exemplary database records, according to embodiments of the present invention.

FIG. 5 depicts an exemplary system according to an embodiment of the present invention.

FIGS. 6A-K depict user interactive displays, according to embodiments of the present invention.

FIG. 7 depicts a flow chart detailing one implementation of a computer software or smartphone application, according to an embodiment of the present invention.

FIG. 8 depicts a flow chart detailing one implementation of a computer software or smartphone application, according to an embodiment of the present invention.

FIG. 9 depicts a flow chart detailing one implementation of a computer software application, according to an embodiment of the present invention.

FIG. 10 depicts a flow chart detailing one implementation of a computer software application, according to an embodiment of the present invention.

FIG. 11 is an exemplary block diagram of a device in which the present invention may be implemented.

### DETAILED DESCRIPTION OF THE PREFERRED EMBODIMENTS

The present invention relates to a method of purchasing jukebox media selections for background play at a Host location using a wireless device such as a smartphone, according to an embodiment of the invention. One aspect of the present invention allows a restaurant or bar customer to wirelessly order jukebox selections using their smartphone or other wireless device.

In a preferred embodiment if the invention, a Host located at a venue—for example, a restaurant, cafè or bar—subscribes to a virtual software-as-a-service (SaaS) jukebox, which allows users of wireless devices such as smartphones or wireless tablets (for example, an iPad) to find the Hosts' physical location on an application installed on their wireless device (e.g. a “jukebox” application) and then browse media choices available for that Host location, choose and pay for their request. In a preferred embodiment, the jukebox application installed on the wireless device will show a limited number of media selections which have just finished playing, are currently playing, or are upcoming in real time.

In another embodiment, a Host location subscribes to a SaaS that allows a wireless device user to use an application to find the Hosts' physical location on an application installed on their wireless device (e.g. a “menu” application) and browse current information on the Host's food and beverage options. Information available from the menu application would be accessed in real time from information available over a communications network and updated by the Host owner, manager, regional manager, or by automated processes.

In one embodiment of the present invention, a backend internet-based dashboard allows an administrative user to update menu information. For example, an administrative user can update a daily special from an interne browser or other client application, and the update would be reflected in real time or nearly real time on the wireless device application accessed by a patron user. In a further embodiment, the menu application will include an interface permitting a user to view which media selection is currently playing at the Host location if the host is subscribed to an SaaS jukebox. In a further embodiment, the jukebox application may include an interface permitting a user to view on their wireless device selections of the Host's menu options, for example, a daily special, if the Host is subscribed to an SaaS menu.

In a preferred embodiment, media available for purchase at Host locations will be stored in a content delivery network (CDN). Several CDNs are currently commercially available, such as, for example, Akamai Technologies, Amazon CloudFront, CacheFly, CDNetworks (PantherExpress), Chinacache, Cotendo, EdgeCast Networks, Highwinds Network Group, Internap, Level 3 Communications, Limelight Networks, PEER 1, Qbrick CDN, WINK Streaming, Windows Azure CDN, and MaxCDN, but any system of computers capable of containing copies of data such as web objects, downloadable objects (media files, software, documents), applications, real time media streams, and other components of internet delivery would be suitable. Such a system would store all media available and stream ordered media via existing communications networks such as internet radio or other streaming or communications methods. In order to, for example, minimize network load, rather than streaming media each time it is requested, the media may be cached locally for short periods of time using Digital Rights Management and expire if not renewed within a set period of time. In a preferred embodiment, each media item will be stored in one or more locations on the CDN, but in fewer locations than there are hosts. For example, a single multi-tenant file may be streamed to multiple Hosts simultaneously.

In a preferred embodiment of the invention, the list of media available for play at the Host location is also stored on a location remote from the Host. Each Host may have a separate server, or two or more Hosts may share a server. Each Host will have its own preferences for its instance of a menu or jukebox SaaS. A Host may configure its instance of the SaaS jukebox server to provide access to the entire catalog of media available, or a Host may select specific songs for its own catalog.

In a preferred embodiment, media requests and payment are handled with hardware separate from media storage, and a media catalog is stored solely or mainly on a CDN, so the equipment necessary to render media requests such as audio (e.g. music) or video clips and to manage media availability can be one or more computers with a user interface, communications interface, video display, and audio output if used to render audio media requests. One example of such an embodiment would be a personal computer equipped with a network connection, browser, an amplifier, audio output, and an LCD monitor or other flat-screen or other video display. In a preferred embodiment, any type of personal computer equipped with an internet connection, an audio output, a browser, and connected to a sound system could be used to play streamed or downloaded media at the Host location.

For example, a browser could be used to open an internet-based application that can stream or download media ordered by one or more users via wireless devices. Such an internet-based application may be browser-based, or may be a proprietary client-server implementation. A media-streaming application or media server may be constructed by combining an internet dashboard with a media server or jukebox engine. In a preferred embodiment of the invention, a jukebox or menu application on a wireless device will communicate with a server for browsing, information, and ordering. The server may include a web-based media streaming and management application implemented using HTML embedded scripting language or other server-side programming language. For example, an open-source instance of a PHP module designed to provide single-user media streaming may be altered to provide additional functionality, for example, the ability to stream to multiple hosts, track user selections, restrict the media selections available at different Host sites, or provide a payment interface. In a preferred embodiment, information sent from one or more server applications to the menu or jukebox application on the wireless device may be stored in a database, flat file, or other data integrated with the wireless application(s).

In a preferred embodiment of the invention the order in which media is played is determined by a server provided on the CDN or other location remote from the Host. In one embodiment, the server may send media selection information, and if the media is already stored on the Host computer, the media will be queued locally. In a preferred embodiment, each time media is ordered selection information is queued at the server and when the selection reaches the head of the queue the media is streamed to the Host computer over a communications network.

Whether a Host media queue is managed locally or at a remote location, the queue management apparatus may include algorithms to ensure that media play conforms with rules set by content licensors such as copyright collectives, performance rights organizations (PROs), or reproduction rights organizations (RROs). Current examples of PROs in the United States include ASCAP, BMI, and SESAC; other PROs exist as well in the U.S. and elsewhere. For example, licensors of music content may have a rule dictating how often a song may be played in public performance in a given time interval. If one or more users request the same song to be played at the same Host location within that interval, one or more instances of the song will be delayed in that Hosts queue until the interval has passed. In a preferred embodiment, a Host will have a default catalog of media that will play randomly if no users have ordered media. This default catalog or default queue may be configurable by a Host or a Host administrator. In a preferred embodiment, if a user requests media in violation of licensing rules, media requested by other users or media from the default queue will play before the users requested media until the rules have been satisfied. Media play from the default queue should also conform to rules set by content licensors.

In a preferred embodiment, media requests and payment are made from a jukebox application or other client, for example a browser, installed on wireless device such as a smartphone or iPad. Such wireless devices may be owned by the user requesting media or by an entity such as, for example, the Host or SaaS provider and leased or otherwise provided to the venue owner or operator. In a preferred embodiment, wireless devices provided by the Host or SaaS provider at a Host location would be loaded with an application to discourage theft, for example, that would allow use of only the jukebox application installed on the device and no other functionality without a security code. The BidPal Network currently provides iPhones with such security features to facilitate charity auctions. A security application might also send an alert if the device were removed from a venue or the vicinity of a venue. An example of a wireless device that may be provided at a Host location might be an iPhone, iPad, smartphone, PDA, laptop computer, tablet, or other wireless device. A device with a wired communications interface located at the Host location or at a remote location might be used by a user to order media for play at the Host location.

For example, a user may use a jukebox application on their wireless device to access a particular Host's jukebox remotely before they arrive, and add media selection or selections to the queue for play upon arrival. An additional fee may be charged for scheduling media play or for a “priority queue.” Additionally, a user may order media to be played at a Host location and have a text automatically sent to a recipient to virtually dedicate the media. A charge may be incurred by the jukebox user for sending such a text message.

A person of ordinary skill in the art will appreciate that a jukebox or menu application must first be installed on the wireless device accessing the SaaS server, but that the installation can be achieved in various ways. For example, the application may be pre-installed on the device by the device manufacturer or distributor prior to purchase, the user may download the application using an application store or web download, the application may be offered via “pop-up” from a Host location communicatively connected with the device when the device is in proximity to the Host, a storage device or computer with the application may be connected to the wireless device, or any other method may be used to transfer and install the application onto the wireless device.

In a preferred embodiment of the invention, payment for media play and other types of transactions (for example, sending a text message or downloading media or the digital rights to media to the user's device, or associating the digital rights to media with the user's device or a user account) will be by electronic means, through, for example, PayPal, iTunes, or by credit card transaction. There may be an option to add purchases directly to the user's bill for communications services. The user may be issued a username and password, for example, to become a subscriber and provide other information through the subscription process to facilitate billing and other aspects of the present invention. A Host may provide the ability to add the cost of media play to the user's restaurant or bar tab. More than one method of payment may be offered. In one embodiment, there may be a set price for instance of each type of media available. In another embodiment, credits may be purchased for amounts to be set by a Host or an SaaS provider. In a preferred embodiment credits may be offered for purchase on a sliding scale, for example, one credit may be purchased for one dollar, three for two dollars, and so on. In addition, media may be offered on a sliding scale where different types or more popular media may be purchased for different amounts of money or credits.

In an alternative embodiment a user may pay for a media play more than once, or pay a variable amount based upon priority. For example, at a charity auction a user may be able to bid on a song to have a certain priority in a play queue, and if they are outbid, raise their bid to maintain the priority of their selection in the queue. In another embodiment, the user may be able to bid only once, with the highest amounts having the greatest priority. Although these embodiments are disclosed in the context of a charity auction, a person of ordinary skill in the art will appreciate that allowing a user to bid or pay extra for queue priority may be used in other contexts as well. In addition, a person of skill in the art will appreciate that other configurations may determine the order in which songs in the queue are played regardless of when they were ordered.

Advertising may be displayed through the jukebox application or menu application on a wireless device. Such advertising may be random, targeted to the user through information contained in their profile or media or venue selection history, or based on the location of the wireless device.

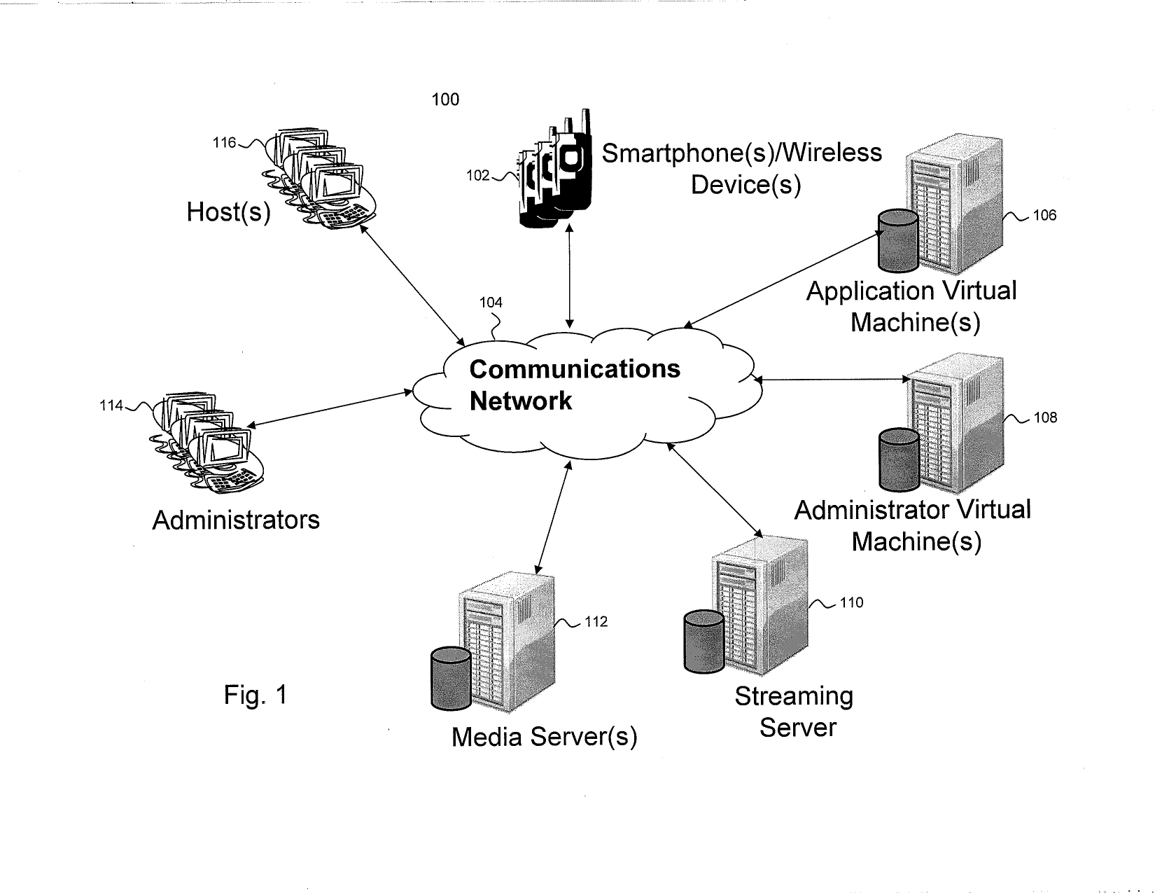

A system of the present invention 100 is exemplified as shown in FIG. 1. FIG. 1 is a block diagram illustrating an exemplary system 100 in accordance with the present invention. A wireless device or devices 102 are communicatively connected through a network 104 to one or more application virtual machines 106 and media servers 112. In some embodiments, the wireless devices 102 may also be communicatively connected to one or more streaming servers 110 and one or more administrator virtual machines 108. One or more application virtual machines 106 may store information about available Hosts 116 and other information aggregated from Hosts 116 such as demographic and administrative information. Hosts 116 may be communicatively connected to one or more media servers 112, streaming servers 110, and administrator virtual machines 108. In some embodiments Administrators 114 may be co-located with or identical to Hosts 116. In some embodiments, Administrators 114 may be communicatively connected with one or more media servers 112, streaming servers 110, and administrator virtual machines 108. Administrators 114 may have a hierarchical relationship with Hosts 116 or with other Administrators 114 such that multiple Hosts 116 or Administrators 114 share settings. This may be advantageous if, for example, a corporation owns or manages multiple venues such as franchises or chain restaurants wishes to manage Hosts 116 on a national, regional, local, or individual basis. In one embodiment, a restaurant manager, regional manager, and national manager may have access to information and account settings for one or more Hosts 116 or venues.

In one embodiment exemplified by FIG. 1, when a wireless device 102 such as a smartphone starts a menu or jukebox application the application connects to an application virtual machine 106. In a preferred embodiment, one or more application virtual machines 106 may be allocated based upon load; if the load of the machines becomes too great, an additional machine 106 may be provisioned. The application virtual machine or machines 106 have a database or flat file containing user information as well as a database of Host venues. The user information may include a name, address, userid and password, and other information about the user including demographic information such as age, gender, and the user's interaction history with the system. When a wireless device user has selected a Host location as described below, the menu or jukebox application is directed to an administrator virtual machine 108 for that Host. In a preferred embodiment each administrator virtual machine 108 may be provisioned for multiple hosts; if the load becomes too great for one or more administrator virtual machines 108 additional administrator virtual machines 108 may be created. In one embodiment, an application virtual machine or machines 106 and administrator virtual machine or machines 108 may be resident on the same server; in another embodiment they may be resident on separate servers communicatively connected on a network. An administrator virtual machine 108 for a Host 116 or a venue may have at least one of jukebox or menu data, or may have both. If a Host 116 is configured for both menu and jukebox, the data for the one Host 116 may be resident on one or more administrator virtual machines 108. In addition, in some embodiments menu data for more than one Host 116 may be shared on one virtual machine 108.

Administrator virtual machines 108 may contain information specific to each Host 116, such as the Host queue 310 as described below, Host menu information, demographic, cost and payment information, media catalog and other information. When a media selection reaches the front of the Host queue selection information such as a URL or other information may be sent to a media server 112 that contains multi-tenant files. A streaming server 110 which may be co-located with or remote from the media server 112 will stream the selected media to the Host location 116. In one embodiment, the streaming server 110 will communicate with each Host's Administrator Virtual Machine 108 when media has completed play; in a preferred embodiment, each Host 116 will communicate with its administrator virtual machine 108 when media play has been completed and the next selection in the queue should be advanced.

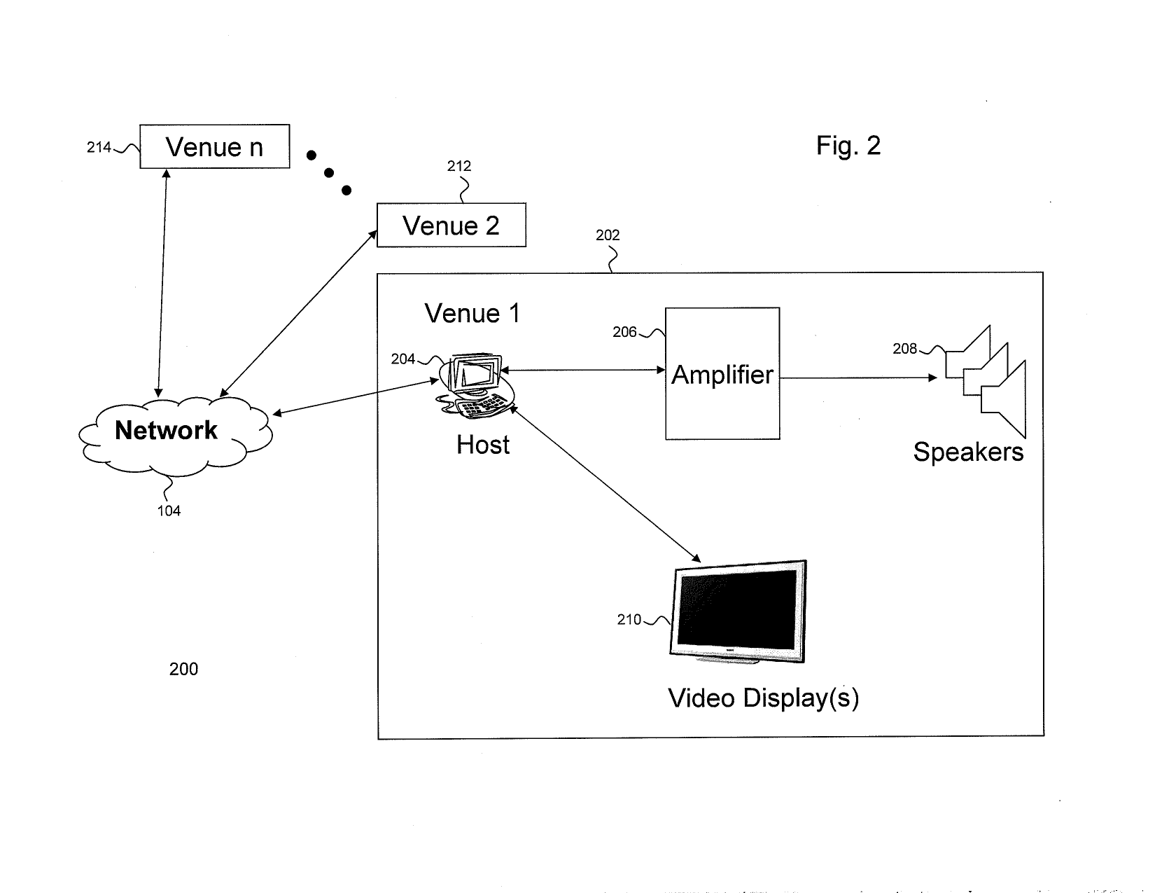

FIG. 2 is a block diagram illustrating an exemplary system 200 in accordance with the present invention. A Host computer 204 located in a venue 202 is connected to one or more amplifiers 206 and thereto to one or more speakers 208. In a preferred embodiment of the present invention the Host 204 is also connected to one or more video displays 210 for Host administrator user interface and/or display of video media selections. The Host computer 204 is communicatively connected to one or more administrator virtual machine(s) 108, media servers 112, and streaming servers 110 through network 104 and equipped with a browser or media client. The browser or client has the ability to control (e.g. start and stop) media play, for example, by logging into a dashboard or media play applet that communicates with one or more streaming servers 110.

In a preferred embodiment the dashboard may have access to administrative functions such as media catalog management, payment history, demographic data and/or analyses, queue history and status, and other functions, in addition to stream control. In one embodiment, only control of media streaming from the queue is typically available from the account login and password typically used by a local Host computer 204, while administrative functions are available from a different user/administrator account. In one embodiment, streaming of queued media is controlled by a wireless device separate from the Host computer 204. In one embodiment, the Host computer 204 does not require a direct user interface for queue management; the media queue is controlled by a separate device. The Host 204 in Venue 1 202 is communicatively connected to servers 108, 110, 112 through the network 104. Other venues 212, 214 may also be connected to servers through the network 104.

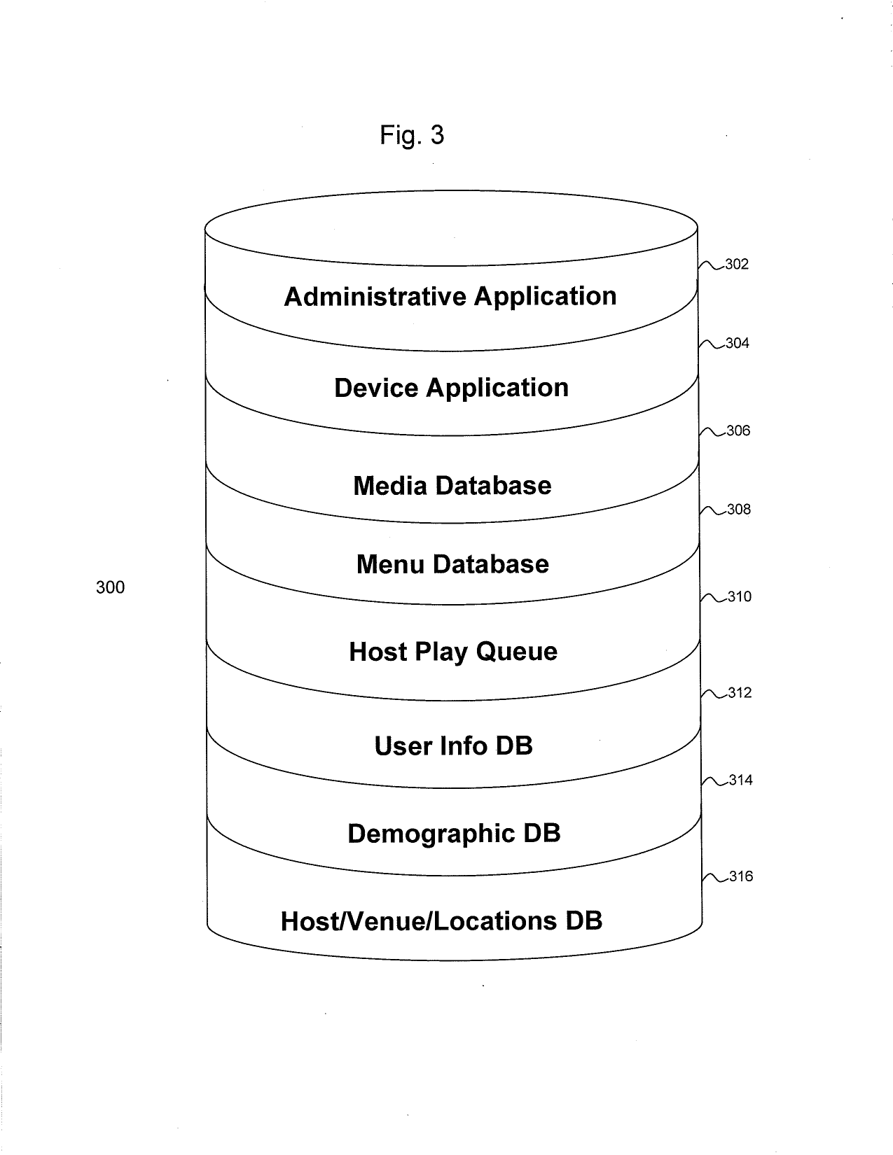

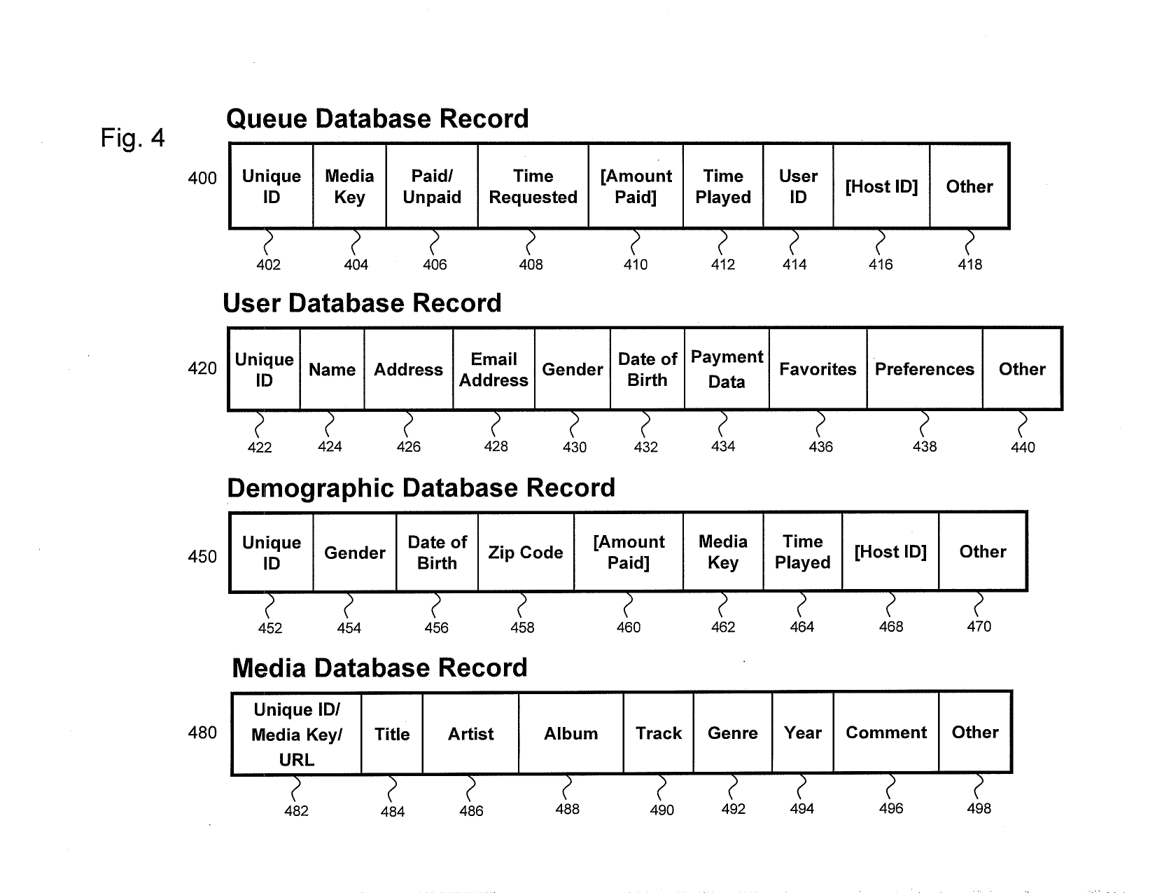

FIGS. 3-4 are an exemplary representation of data that may be kept in one or more servers 106, 108, 110, 112 in embodiments of the present invention. In one embodiment of the present invention databases 306-316 or other data representations such as a flat file may be mirrored on one or more machines 106, 108, 110, 112. Administrative application 302 may interface with Host 116 or Administrator 114 computers through a web browser or other client and Device application 304 with wireless devices 102 through an application installed on the device; Administrative and Device applications 302 and 304 may also interface with data sources 300 co-located on the same server or remotely located on a server communicatively connected with the applications. In a preferred embodiment, a media database 306 stores metadata information 480 about media available in the catalog. Metadata 480 may include one or more elements of ID3 or other metadata container info such as title 484, artist 486, album 488, track number 490, genre 492, year 494, comment 496, and other information 498 about the file, for example, album or case cover graphics. The metadata 480 may include a unique identifier 482 used to locate the media in a catalog. In a preferred embodiment, the unique identifier 482 may be a URL. In another embodiment, the unique identifier 482 and the URL may be distinct fields. In a preferred embodiment, the media database 306 is stored on a separate server from the media which are kept as individual files, for example, the metadata 480 of the media database 306 is on one or more media servers 112 and the media itself on one or more streaming servers 110.

A menu database 308 is preferably maintained in conjunction with an administrator virtual machine 108 and contains information about food, beverage, and other information regarding the Host establishment. The Host play queue 310 is preferably maintained in conjunction with an administrator virtual machine 108. An exemplary queue record 400 is shown with reference to FIG. 4. A queue record 400 indicates a media selection in the queue to be played (where a media selection may have been selected by a user or randomly added from a default queue). A queue record 400 may contain two or more of a unique identifier 402, a record uniquely identifying the media queued 404, whether the selection was purchased 406, the time the selection was requested 408, the amount paid 410, the time the selection was played 412, the unique identifier of the user who made the selection (if any) 414, and other information 418 as may be useful or necessary for tracking selections. For example, if the queue database were to be shared among more than one Host, a queue record may indicate the unique Host where the music was queued 416.

A user database 312 is preferably maintained in conjunction with an application virtual machine 106, but a copy of the user database 312 or a subset corresponding to users who have recently selected a Host 116, 204 or venue 202, 212, 214 may also reside in conjunction with an administrator virtual machine 108. An exemplary user record 420 is shown with reference to FIG. 4. A user record 420 may contain two or more of a unique identifier 422, information about the users name 424 and address 426, the user's email address 428 (in a preferred embodiment this will correspond to a user's login name), gender 430, date of birth 432, payment preferences 434, favorite songs playlists, or Hosts 436, preferences 438, and other information as may be useful or necessary for identifying users 440. In one embodiment of the invention some of the information is maintained on the user's wireless device 102 and only sent to a server when requested.

A demographic database 314 is preferably maintained in conjunction with an administrator virtual machine 108. In a preferred embodiment, one or more demographic databases 314 are maintained separately from a Host- or Administrator-designated administrator virtual machine.

An exemplary demographic record 450 is shown with reference to FIG. 4. A demographic record 450 preferably contains information related to users but not including personally identifiable information. A demographic record 450 may contain two or more of a unique identifier 452, gender 454, date of birth or age range 456, zip code or other location code 458, the unique identifier of a media selection 462, the amount paid for a selection 460, the time the selection was requested, the time the selection was played 464, a unique Host identifier 468, and other information 470 as may be useful or necessary for tracking catalog information. A person of skill in the art will appreciate that a demographic database may, for example, be used to analyze patterns of music purchases. Such information may be used by, for example, a user of a Host 116 or Administrator 114 to more accurately identify the types of media preferred by patrons, or by creators or disseminators of media to identify consumer trends. In one embodiment, a demographic database 314 may be derived from queue 310 and user 312 databases. In another embodiment, a demographic database 314 may be generated independently when media is selected by a user for queuing at a Host 116.

A Host or Locations database 316 is preferably maintained in conjunction with one or more application virtual machines 106. A Host database 316 contains two or more pieces of information about available Hosts 116 such as a unique identifier, name, logo, coordinates, whether jukebox or menu functionality is available, ratings or reviews, genres of music available from the Host catalog, and other information as may be useful or necessary for identifying and/or choosing a venue or Host 116.

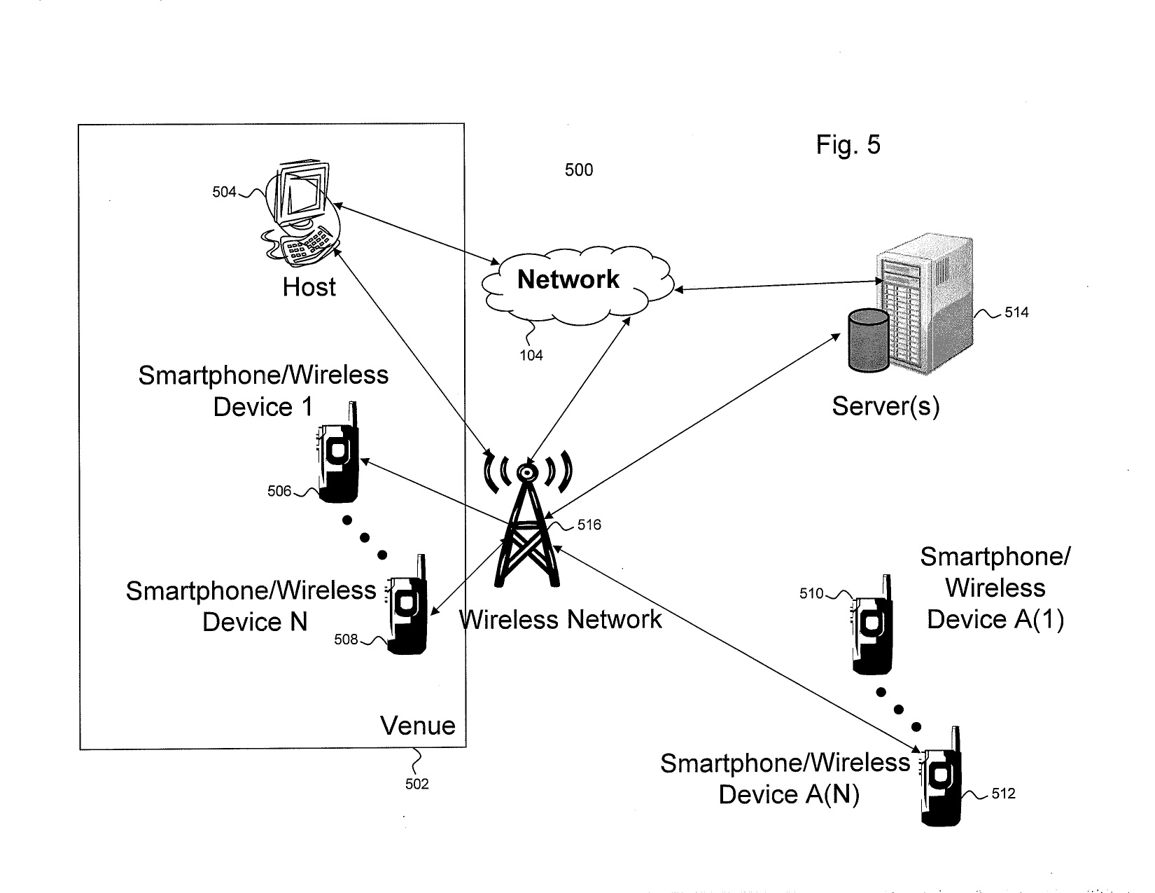

FIG. 5 is a block diagram illustrating an exemplary system 500 in accordance with the present invention. Wireless devices 506, 508, 510, 512 within, near or remote from a venue 502 are communicatively connected to one or more servers 514 through a wireless network 516 and optionally through an additional connection to a wired network 104. A Host computer 504 located within the venue 502 is connected to one or more servers 514 through wired 104 and/or wireless networks 516.

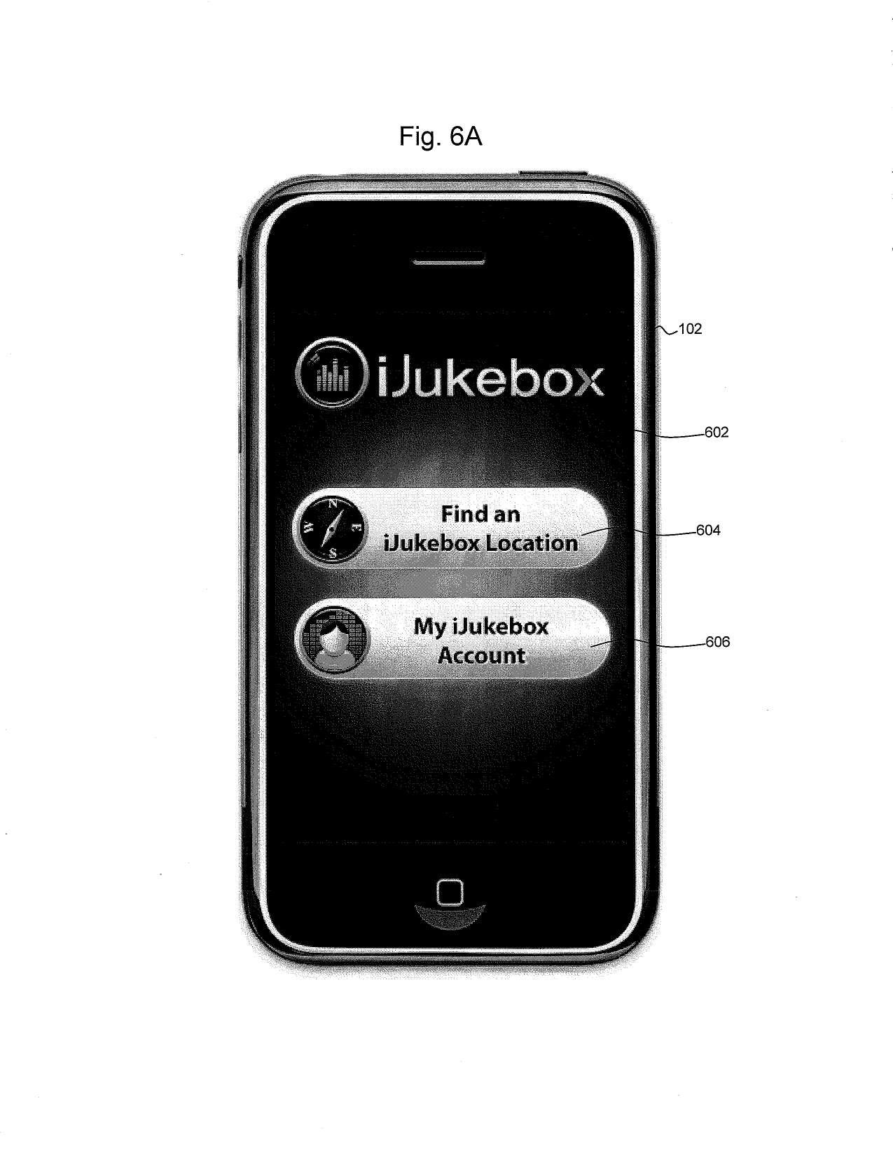

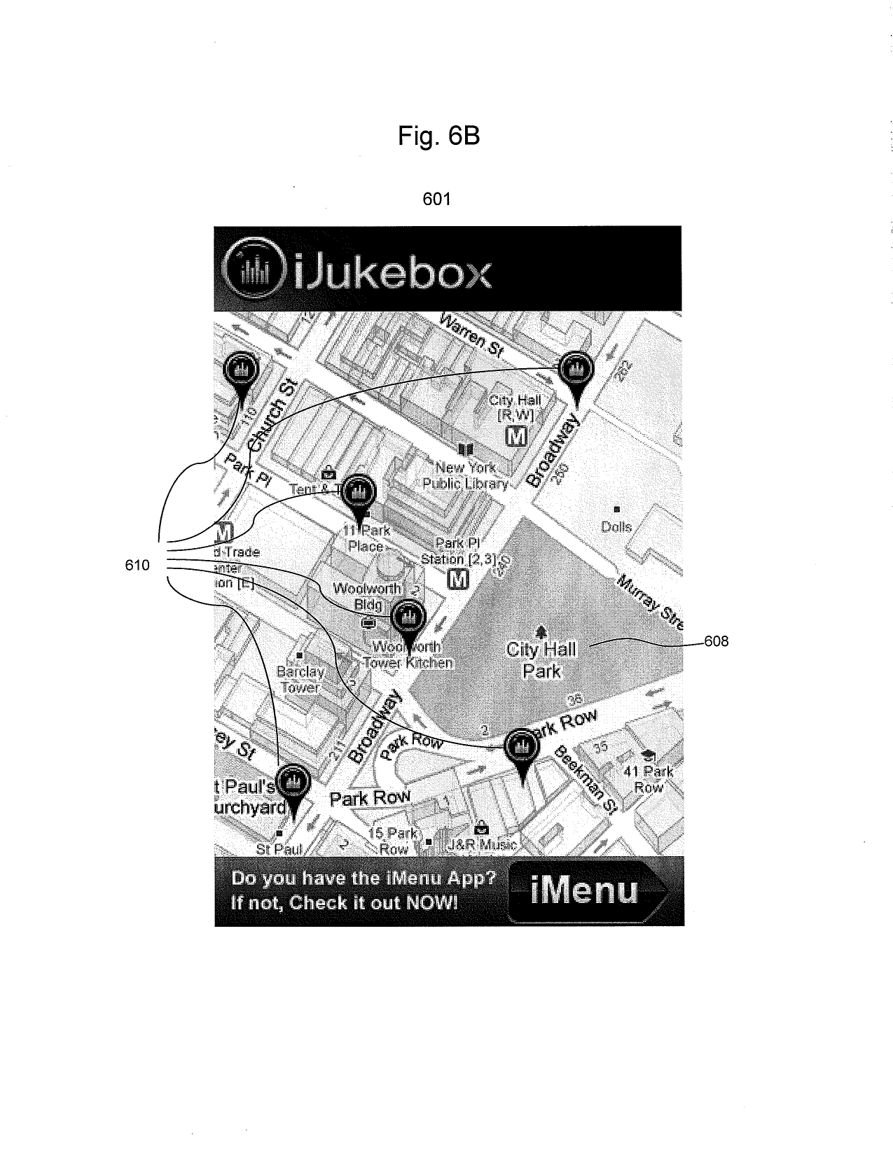

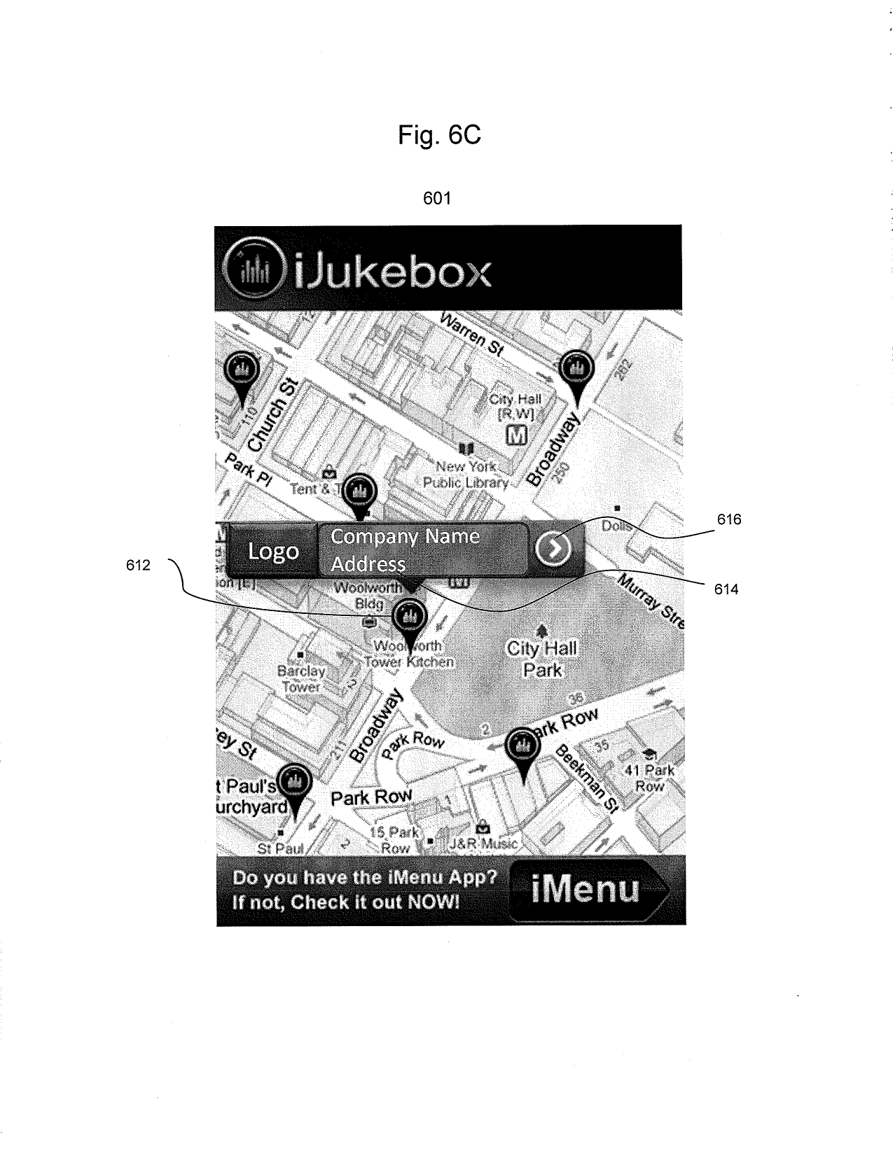

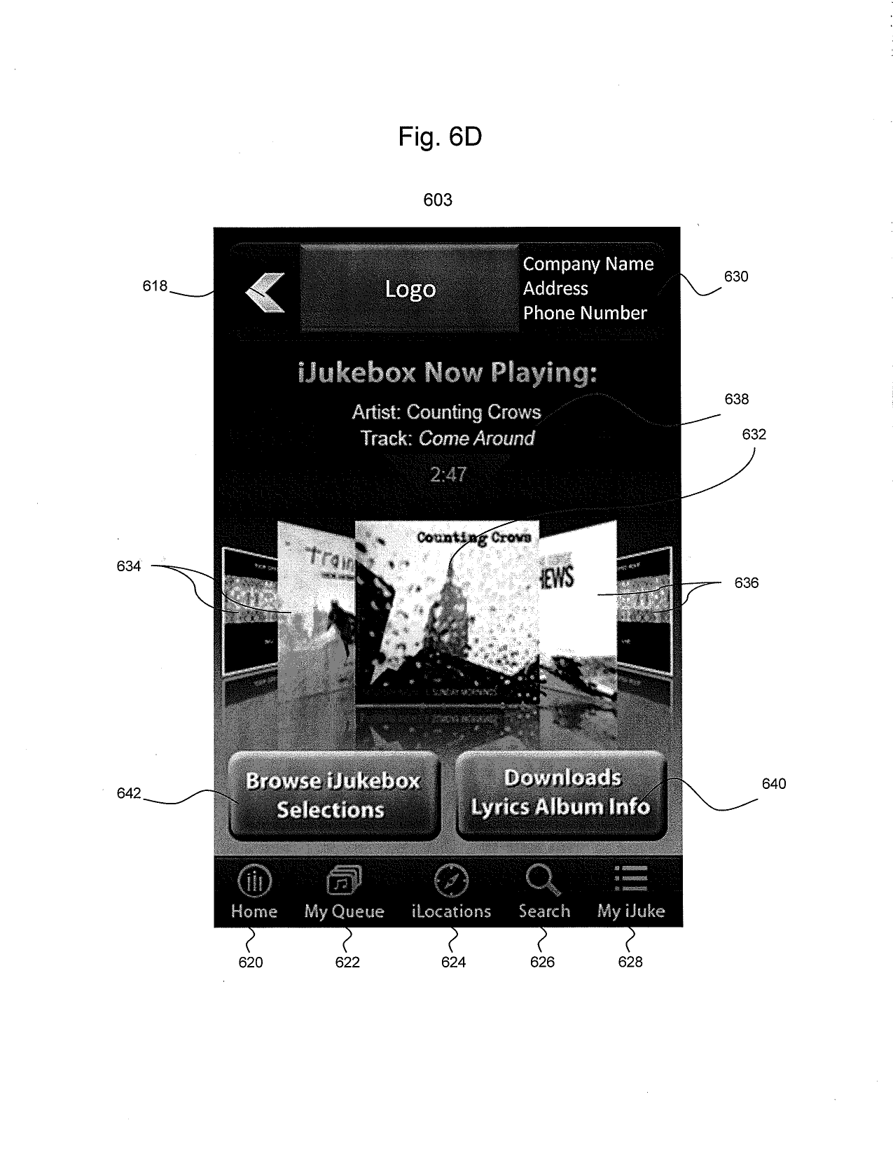

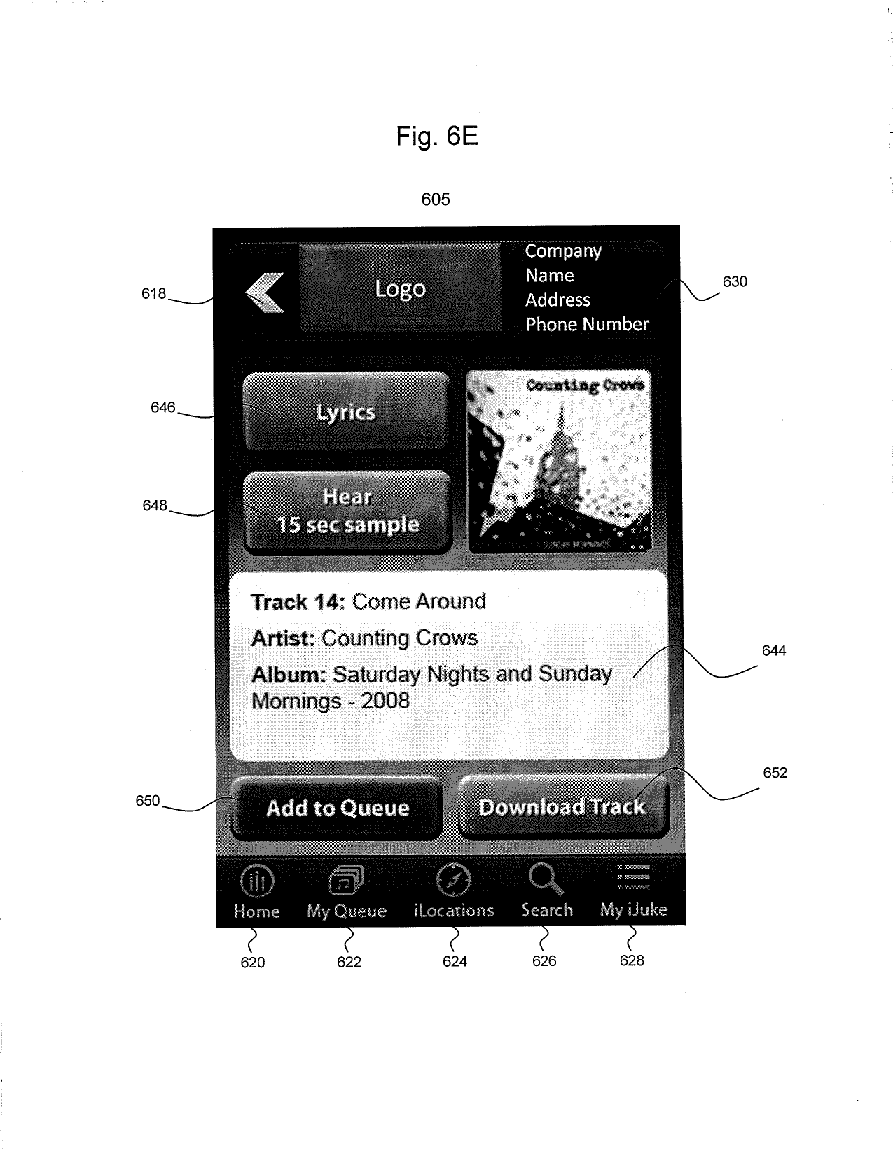

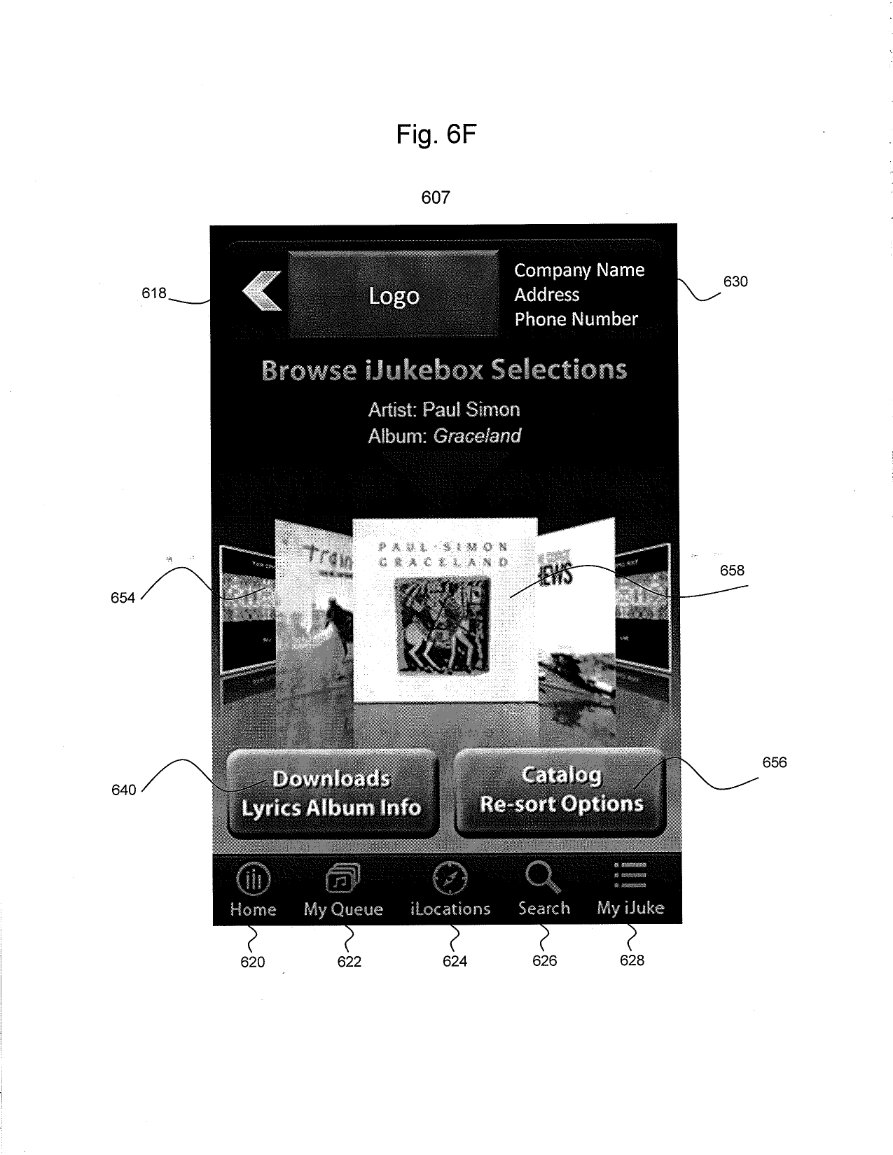

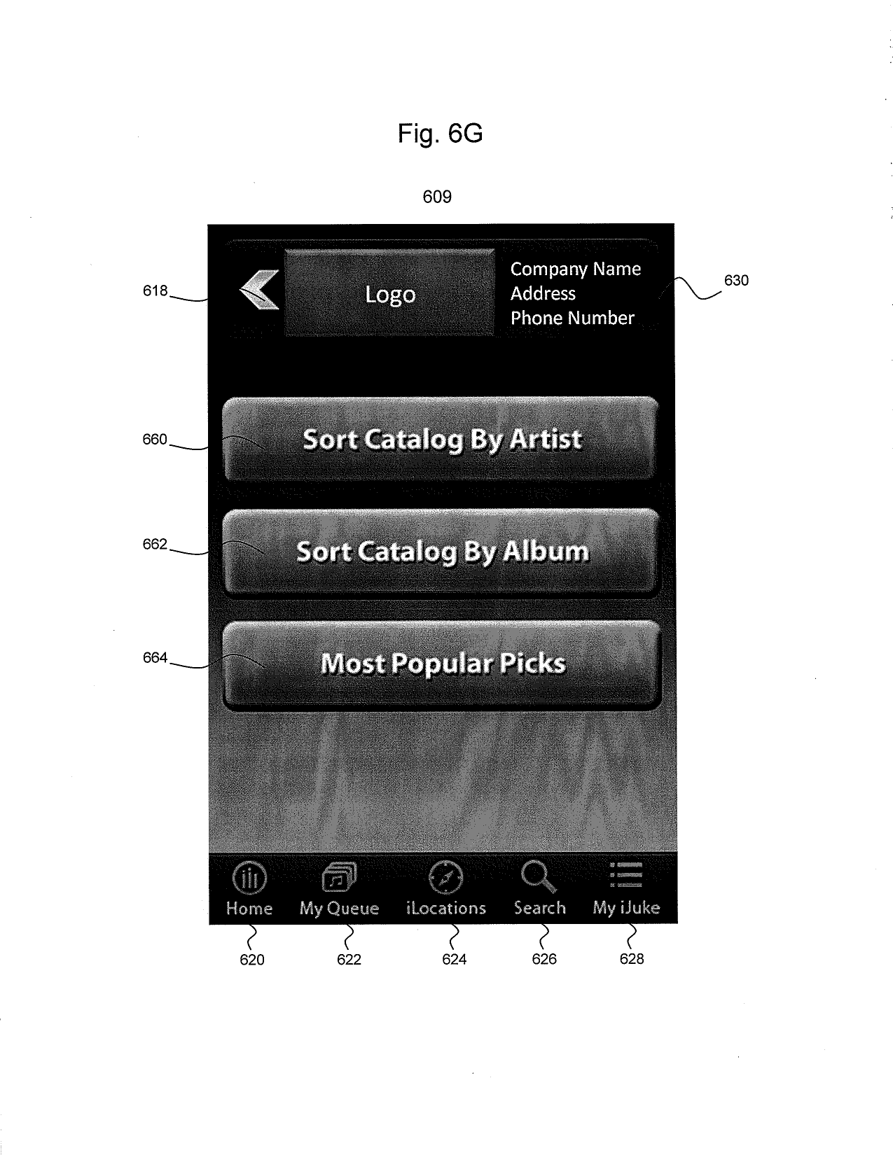

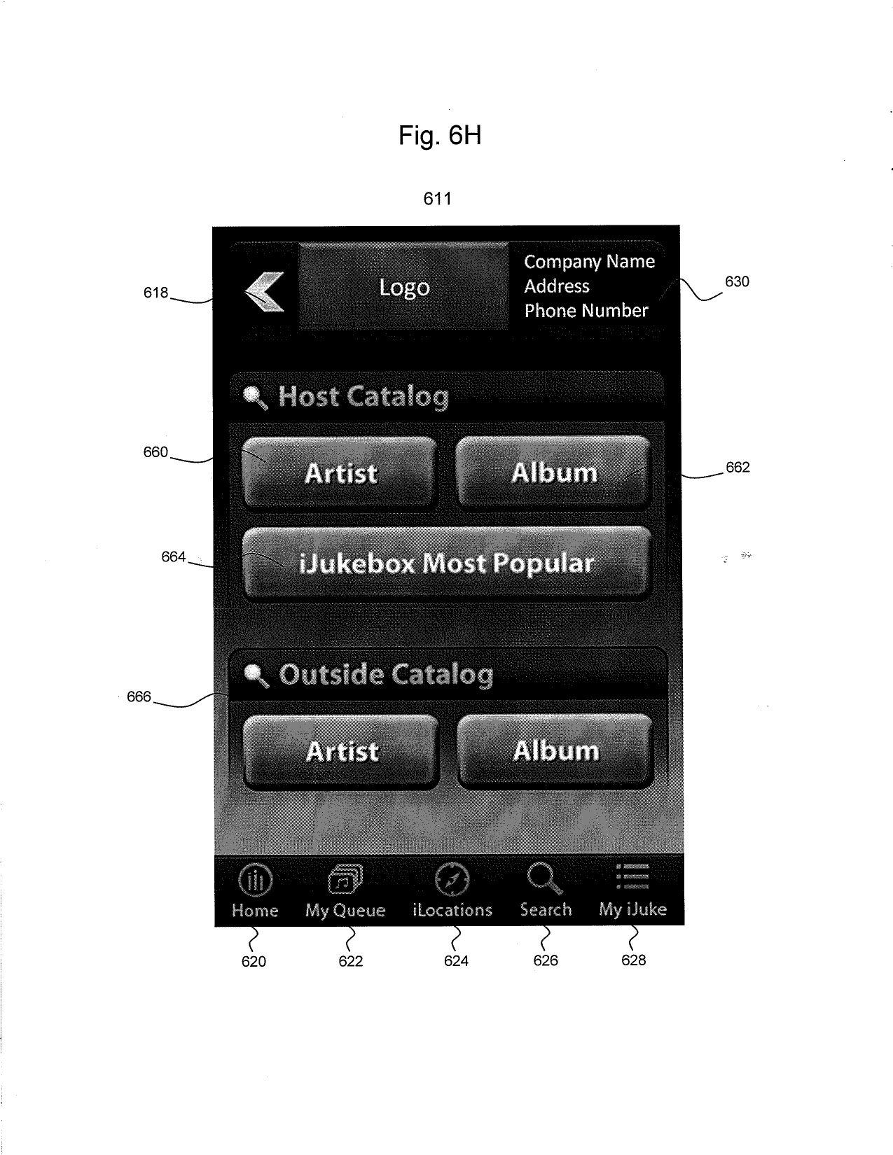

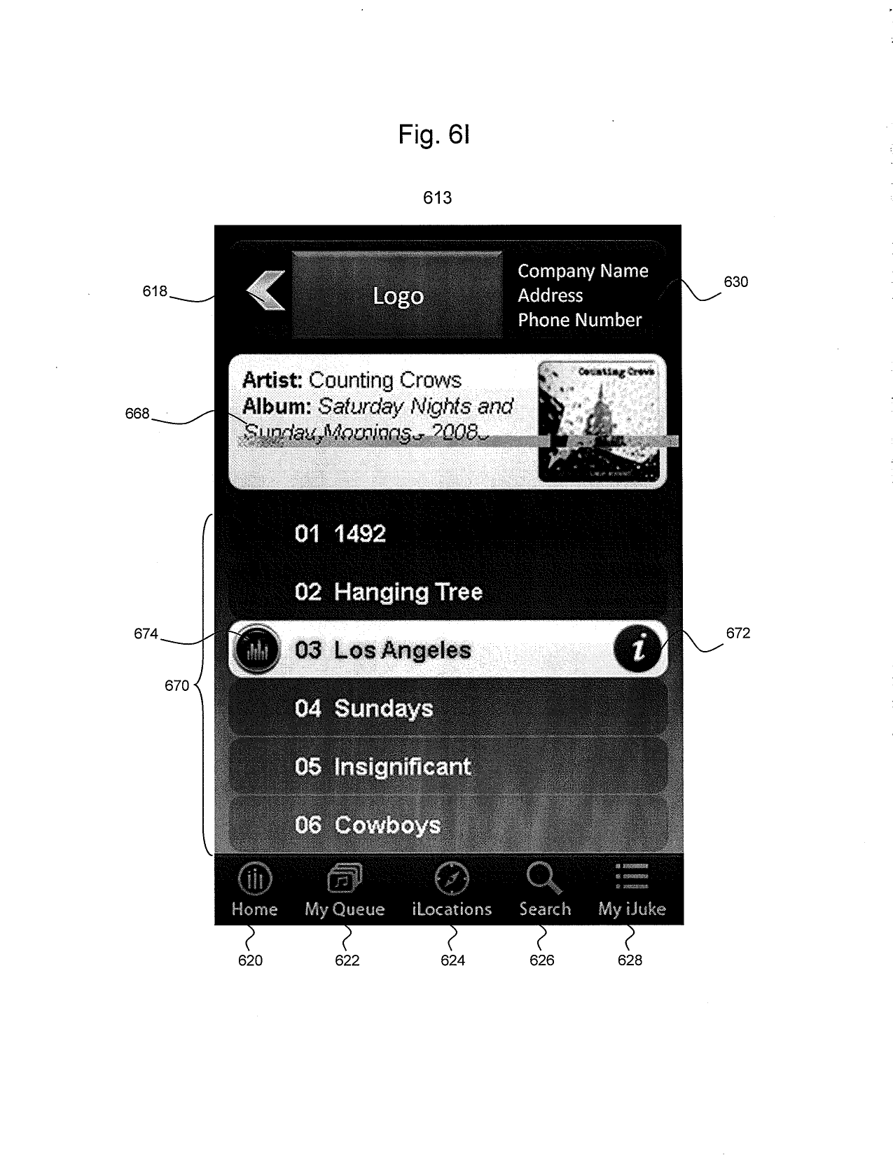

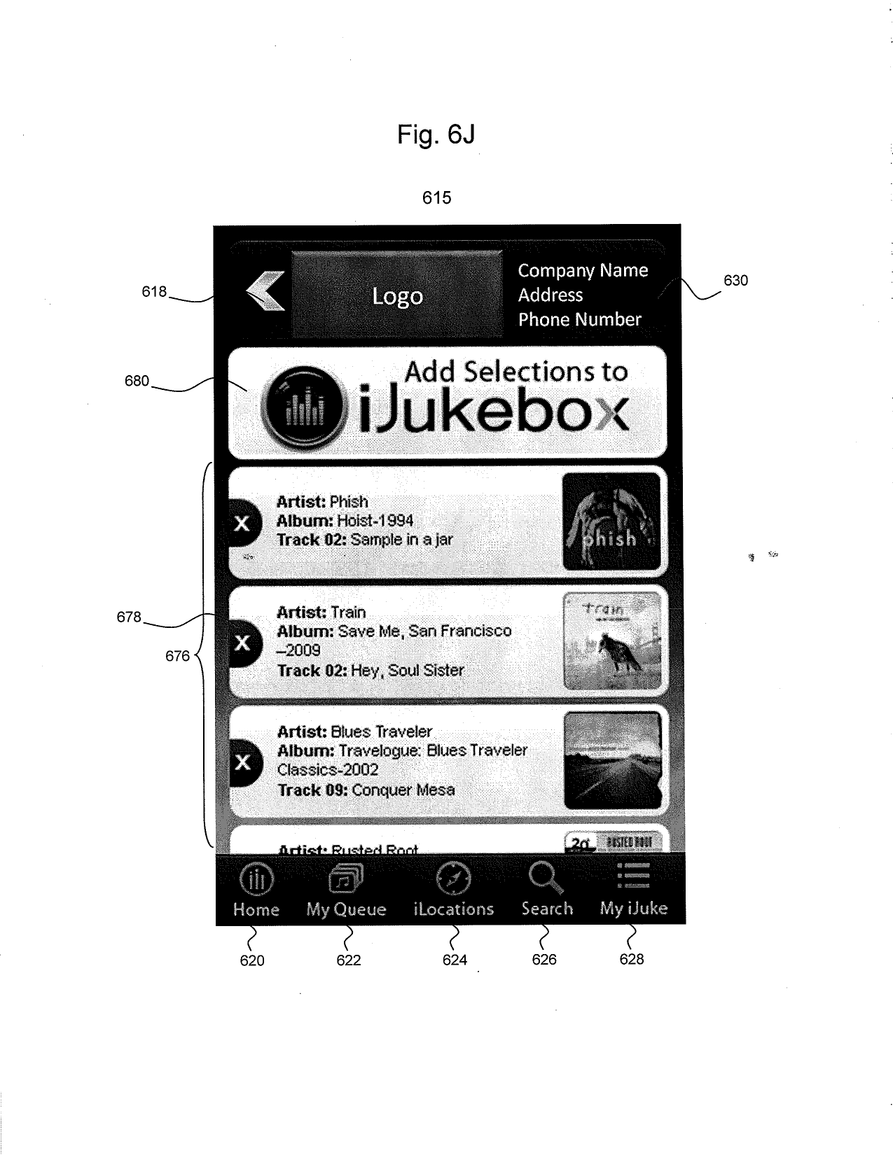

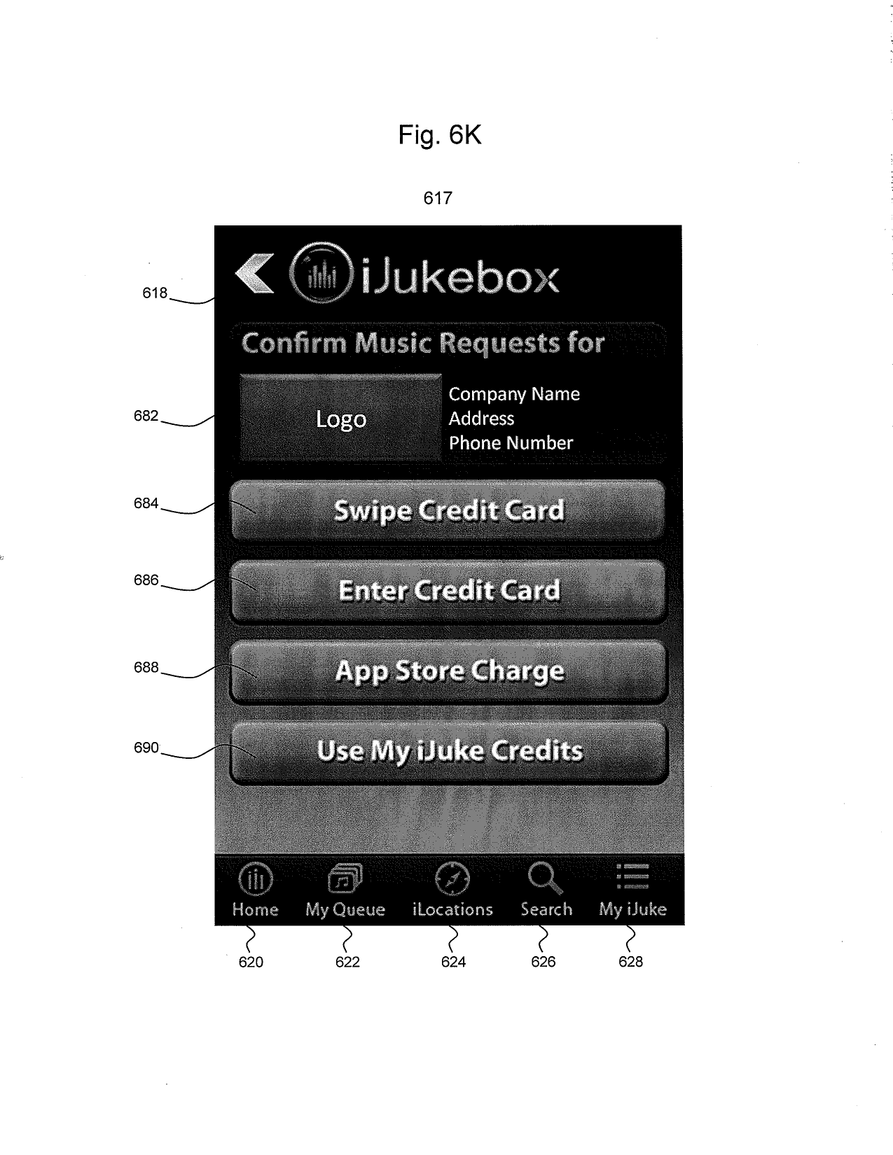

FIGS. 6A-6K depict an embodiment of the present invention, a method of ordering media to be played at a host location through a wireless device. In a preferred embodiment, the wireless device will have a touch-screen interface, but a person of ordinary skill in the art will appreciate that the present invention may be implemented using any user interface such as a trackball, wheel, number keys, keyboard, trackwheel, or touchpad.

Referring to FIG. 6A, when a wireless device 102 user opens a jukebox application 602, the user may be presented with the options to find Host locations 604 or to access their account settings 606 such as personal information including email or physical address, payment information, favorite Host locations or media, or other preferences such as visual appearance of the application or hotkeys. In a preferred embodiment the users preferences are stored on the wireless device 102. In another embodiment user preferences are stored on a server maintained by the SaaS provider, or in a combination of a device database and information maintained by the SaaS provider.

In a preferred embodiment of the invention, if the user chooses to locate a Host location 604 the application will display an interface 601 so that the user may find a Host location using a “Location Finder” 608. The Location Finder 608 may initially display a map of one or more Hosts 610 nearest the physical location of the wireless device 102 such as that exemplified in FIG. 6B. In alternate embodiments, a map displaying the area surrounding the physical device, a default location selected by the user or pre-selected, or a text list of hosts and their addresses may be displayed 601. The display 601 may include a field with a text entry for selecting an alternate location using, for example, an address, zip code, city, or other coordinates such as latitude and longitude. The size of the area or “zoom” of the map may be configurable. If a text list is displayed, the size of the area to be searched, for example, 1 mile, 5 miles, 10 miles, etc., may likewise be configurable. In a preferred embodiment, information 316 used to generate the map or list of Hosts 610 will be stored at a server communicatively connected to the wireless device 102.

In one embodiment of the invention, the Hosts 610 that are displayed 601 are restricted by user- or server-configured or default preference. For example, in the case of a charity auction, a user may access an email invitation from their wireless device 102, and upon accessing an interactive feature such as a link an application may open with the location of a specific charity auction for the user to participate in, or all charity auctions within a defined area and scheduled period of time displayed. In another example, a user may choose to see only venues that serve alcohol, or coffee, or other selection criteria. In one preferred embodiment, Hosts 610 may be selected based upon combinations of criteria such as, for example, activity (e.g. dancing, video games, bar games, live music and/or music genre), food or atmosphere type (e.g. burgers, French, casual, elegant), whether background music is available and what genre (e.g. jazz, Rock-and-Roll, eclectic, etc.), or the specials for the day. In another example, available Hosts 610 may be displayed based upon a user's previous Host selection criteria.

If a map is shown, locations of available Hosts 610 may be displayed. In the case of a touchscreen, if a user selects a Host location 612 information about the Host may be displayed 614, for example as shown in FIG. 6C. In a preferred embodiment information displayed when a location is selected may include the Host name, address, and logo if available. In other embodiments other information such as ratings or links to the Hosts menu may be displayed. This information may be accessed from an SaaS server when the location is chosen, or in an alternate embodiment at the time a list of Hosts 610 is generated all of the information about the listed Hosts on a list may be temporarily stored on the device 102 pending user selection. In a preferred embodiment of the invention, in the display exemplified by FIG. 6C a user may select 616 the restaurant location whose information is displayed, choose another location, or change locations to be searched. In still another embodiment, if the user opens the application from a device such as a smartphone with GPS or other location determination functionality active, and the location information coincides with a Host location 612 known to the jukebox application, the user will be prompted to select that particular location or that particular location will be set as a default Host location selection.

If the user selects 616 a Host location 612 in the display shown in FIG. 6C, a Host home page 603 such as that in FIG. 6D may be displayed to allow the user to make selections and view information related to the Host or application. For example, a standard menu option may allow the user to return to the previously displayed screen 618. Other standard menu options may allow the user to access media they previously selected for possible purchase (the user's “queue”) 622, see other Host locations in the Location Finder or another format 624, return to the first screen of the application 620, search for media 626, access their preferences 628, or take other actions. In one embodiment, a standard menu may display information 630 about the currently selected host such as its name, address, logo if available. In one embodiment, such information 630 about the Host may be a selectable menu option such that it if selected it may display additional information about the Host such as a food menu, user ratings or other reviews, or information about its corporate parent or related establishments. These or other standard menu options 618, 620, 622, 624, 626, 628, 630 may be displayed in more than one screen 603, 605, 607, 609, 611, 613, 617 as shown in FIGS. 6D-6K.

In a preferred embodiment the Host home page 603 such as the example shown in FIG. 6D will display media that is currently playing 632 as well as for the three media that played in the immediate past 634 and the three media that are next 636 in the Host's play queue 310. In a preferred embodiment of the invention information about the Host queue, Host catalog, media information, and other information related to the Host, media, and media catalog described below may be accessed from the SaaS server 106, 108, 110, 112 or other location remote from the Host 116 and the wireless device 102. Information unique to the user may be stored on the wireless device 102, for example, in a flat file or database (for example SQL database or other database) on the device, or may be stored on a remote server.

The user may choose to interface with the Host home page 603 using visual or menu elements displayed. In one embodiment, the display 632, 634, 636 of the Host media queue 310 on the home page 603 may be interactive to allow the user to scroll through the queue, display additional information about media 638 and select a media icon to enter a display of options for the media displayed in the queue or catalog such as that exemplified by FIG. 6E. In one embodiment, the home page 603 may provide a menu option to view the media selections available in the Host's catalog 642 in a display such as that exemplified by FIG. 6F. If no additional information is available about media, the user may be given the option to purchase the media for download or order the media for background play 640 at the Host location.

In addition to one or more standard menu options 618, 620, 622, 624, 626, 628, 630 the media detail screen 605 exemplified by FIG. 6E may show one or more pieces of information about the media 644 or provide one or more interactive options 646, 648, 650, 652. Information about media 644 may include the title, its number in the order of play if it came from a media collection such as, for example, a music album, the artist, the name of the collection, and other information. The display 605 may provide interactive options such as the ability to see additional information about the media 646, for example, lyrics, media history, or a audio or visual sample 648, the option to purchase the media for download 652, or the ability to add the media to the user's queue 650 for purchase as jukebox play on the Host's queue.

In addition to one or more standard menu options 618, 620, 622, 624, 626, 628, 630 the display 607 exemplified by FIG. 6F may allow a user to browse the media selections available at the Host location 612. The media selections available at the Host locations may include any media available from a default catalog, media selected by an administrator 114 local to the Host 116, or an administrator 114 with administrative privileges over one or more remote Host locations 610 or groups of Hosts 116. A user may browse through a media catalog by scrolling using a touchscreen displaying visual representations of the available media 654 such as that shown in FIG. 6F, or through a text list, or by selecting text menu options. The media may be shown as individual media selections or as collections, for example, as albums or collections of media by the same artist. The method of displaying the catalog may be configurable, for example, the user may be given the option to re-sort the catalog 656 with options such as that shown 609 in FIG. 6G. The user may be given the option to display the catalog by artist 660, by album 662, by genre, by the most popular selections at that location or at select locations 664, by that user's favorites based upon actual play or selected preferences, in alphabetical order, or in other orders.

In another embodiment of the invention, if the user chooses a menu option allowing them to view a catalog from one or more screens 603 where such an option is displayed 642, they may be asked what the preferred sort order is before being shown the catalog; in one embodiment the user may be given the option to view a Host's catalog or a catalog separate from the Host such as that at another location or at all locations 666, for example, through a display 611 such as that exemplified by FIG. 6H.

In one embodiment, if the media available from a Host catalog is displayed as albums, selection of an album, for example, in the case of a touch screen, by tapping or otherwise selecting an album cover 658, a display of the media available in the collection may be displayed in a manner exemplified by FIG. 6I. In addition to one or more standard menu options 618, 620, 622, 624, 626, 628, 630, a display 613 of the media available in a collection may include information regarding the catalog such as the artist and name of the catalog 668, a list of the media 670, the order of the media in the collection 670, or the type of media such as audio, video, audio/visual, or interactive.

In one embodiment of the invention, all media in the collection may be shown whether it is available for play at the Host 116 or not; in one embodiment, information of whether the displayed media is available for play may be shown in the collection screen. In another embodiment, media that is not available for play at the Host will not be shown. In a preferred embodiment, if additional information about the media is available an icon or other selectable option will be shown 672 allowing access to a display 605 such as that shown and described with reference to FIG. 6E. In one embodiment the user may be allowed to add media to the user's queue by selecting the media or a portion of the display of the media 674.

In a preferred embodiment of the invention, when a user chooses an option to add media to the user's queue 650, 674, the user will be presented with a display asking the user to confirm selection of the media. In one embodiment of the invention, confirmation of media selection will display the user's queue 615 as shown in FIG. 6J. In one embodiment of the invention, the user may choose to open their media queue by choosing a menu option 622.

In addition to one or more standard menu options 618, 620, 622, 624, 626, 628, 630 the display 615 exemplified by FIG. 6J may allow a user to browse the media selected but as yet un-purchased by the user 676. In a preferred embodiment, an interactive display allows the user to view, re-order, or delete 678 media from the user's queue. In a preferred embodiment the user may add 680 one media selection at a time, a subset, or all of the media in the user's queue 678 to the Host queue 310. In a preferred embodiment of the invention, when the user chooses a menu option to add 680 one or more media items 678 to the Host play queue 310 the user will be taken to a payment or checkout display 617 such as that exemplified in FIG. 6K.

In another embodiment of the invention, the user will be asked via a visual display 617 to confirm that they wish to add media to the Host 310, and upon selection of a confirmation option 682 a default method of payment previously selected by the user will be employed; for example, a pool of previously purchased or allocated credits may be deducted, a credit account may be charged, or other method of payment. In one embodiment, purchased media selections may be added to the user's bill at the Host location 612 such as a food or alcohol tab. A person of skill in the art will appreciate that many types of venues may use a system where customers purchase media for play such as a bowling alley, video arcade, recreational area, or other public entertainment venue. Such venues may or may not offer customer the option to run a tab, and different Host locations may be configured to offer different payment options.

If a user does not have a pool of credits or other automatic payment options configured or available, or in a preferred embodiment of the invention, once the user elects to add media to a Host's queue 680 the wireless device 102 will display a screen 617 such as that exemplified by FIG. 6K showing payment options. In one embodiment the user may have the option to merely confirm payment 682 using preconfigured payment preferences. In one embodiment the device may have an attached or communicatively connected credit-card swipe, and an option for the user to swipe their credit card may be displayed 684. In other embodiments, the display may show options to enter credit card information 686, charge an amount to an application store 688 provided by the wireless device manufacturer, wireless service provider or other provider, use previously purchased credits or purchase a pool of credits against which current and future purchases may be deducted 690, or other payment options such as adding the amount to the Host bill or bank transfer.

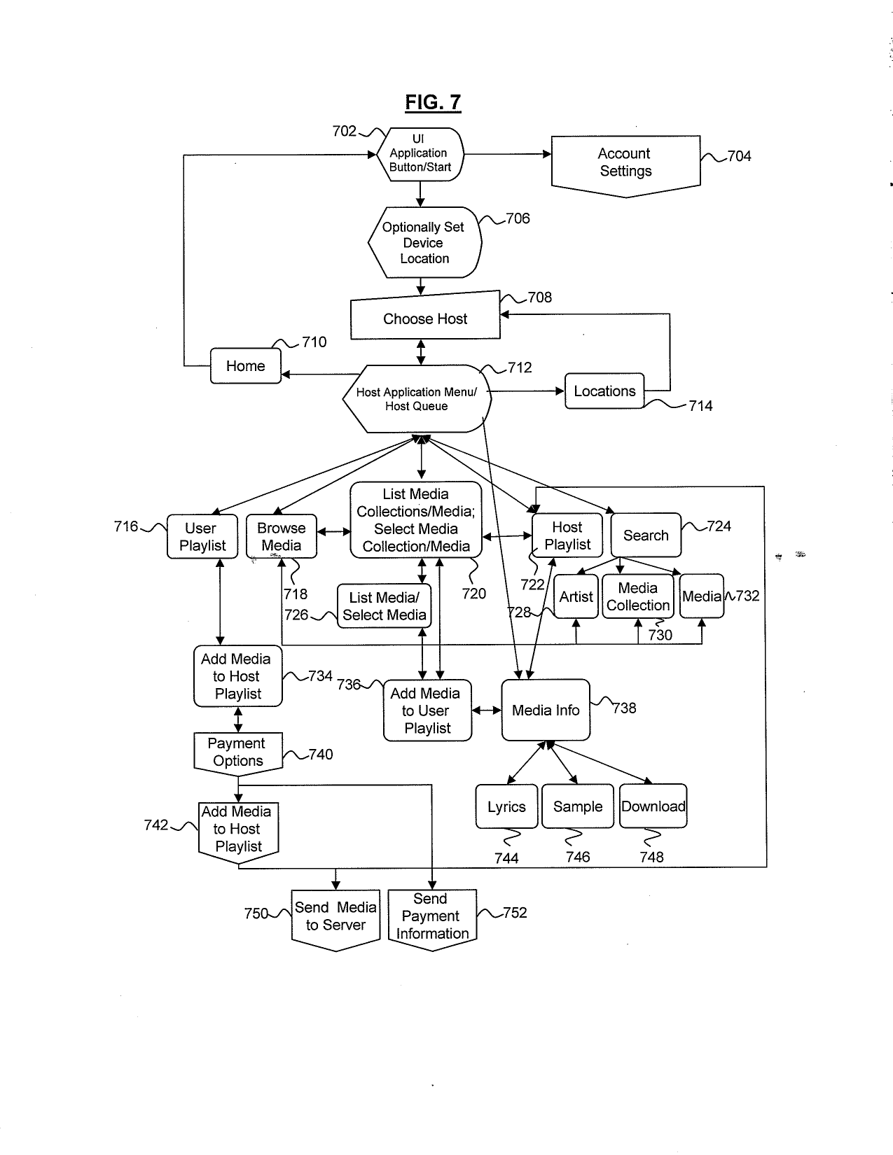

FIG. 7 is a flow chart that depicts an embodiment of the present invention, a method of providing queued content selection and delivery to geographically distributed venues and providing ancillary information and services related to such venues, including smartphone application for ordering and paying for jukebox selections, and a jukebox software service implemented with client-server architecture. Referring to FIG. 7, when a wireless device user opens a jukebox application 702, the user may be presented with the option to set their device location 706 or to access their account settings 704. In a preferred embodiment the device location will default to the actual location of the device using wireless transmission triangulation, GPS, or other directional indicators. Once a location is chosen the user is given the opportunity to chose a Host 708 from a list generated based upon proximity to the device location as entered or defaulted to. A default Host may also be set based on prior selections or other criteria.

Once a Host is chosen or set, information pertaining to the host is displayed on the wireless device, for example, the Host media queue and menu options 712. From the initial page a user may choose to return to the program opening screen 710, change Hosts 714, view the user's current playlist 716, browse the media catalog 718 or search the media catalog 724 by artist 728, media collection name 730, or media name 732, see details of media in a portion of the Host media queue 738, list the media collections available at the Host 720, or see the Host playlist 722. When viewing an individual item of media either in summary 720, 726 or detail form 738 a user may add the media to their playlist 736. Detail information 738 may include media title, collection information, artist information, lyrics or dialogue 744, a sample 746, or the opportunity to download the media or the digital rights to the media 748. Once media is added 736 to a user playlist 716, the user may add the media to the Host playlist 734, optionally for a fee. After the user has arranged for payment of the fee 740, for example by credit card or application store charge, the media is added to the Host's play queue 742, media is added to the queue on the streaming server 750 for play at the Host location, and payment information is sent 752 to one or more payment processors.

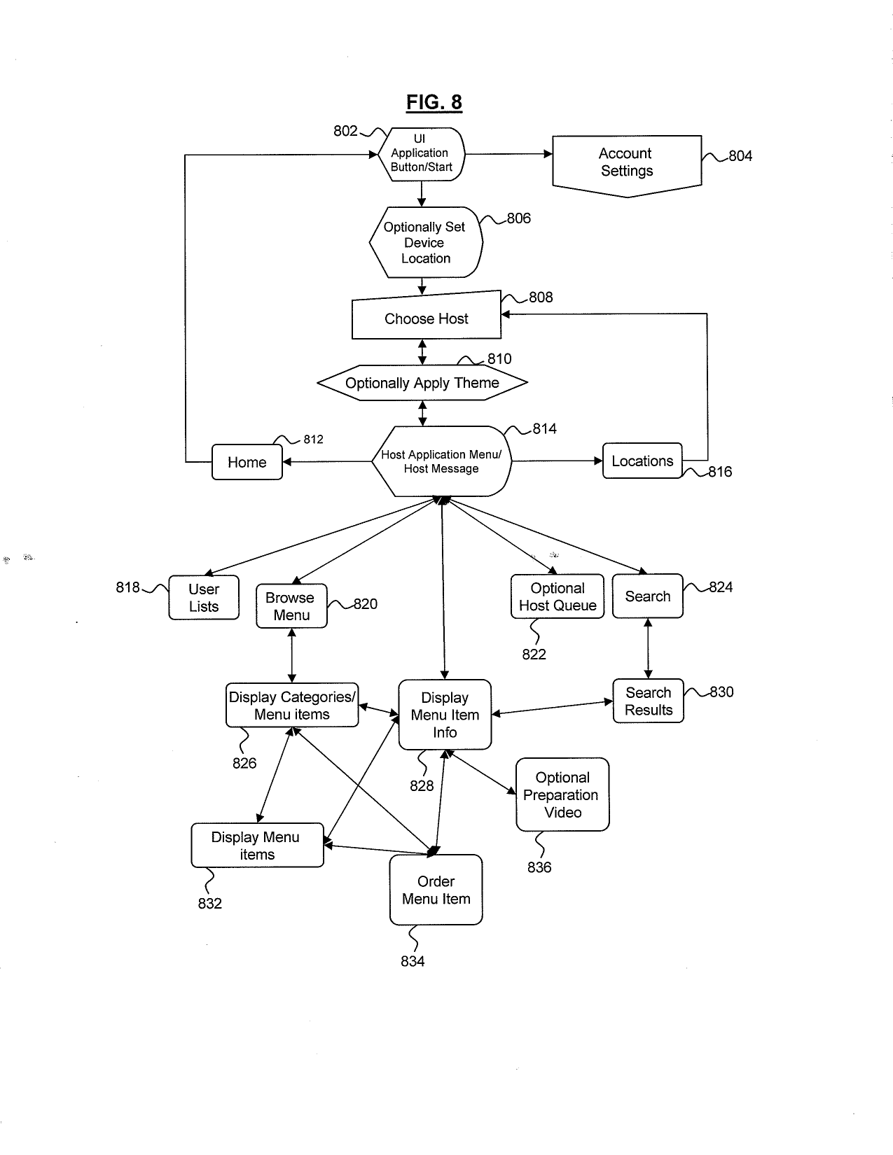

FIG. 8 is a flow chart that depicts an embodiment of the present invention, a method of providing menu information and selection to geographically distributed venues and providing ancillary information and services related to such venues, including a smartphone application for ordering and paying for food selections, and a menu software service implemented with client-server architecture. Referring to FIG. 8, when a wireless device user opens a menu application 802, the user may be presented with the option to set their device location 806 or to access their account settings 804. Once the location is set using any of the methods described elsewhere with regards to jukebox applications, the Host for the session may likewise be set 808 using any of the methods described elsewhere. Once the Host is chosen a theme for the venue such as color scheme, font type and size, venue logo and other information may optionally be downloaded to the device 810.

Once a Host is chosen or set 808 and a theme is optionally downloaded 810, information pertaining to the Host venue is displayed on the wireless device, for example, a message of the day or daily specials 814. In a preferred embodiment the Host menu shares the display with the default information. In another embodiment, only information about the venue and an application menu are shown. From the Host menu a user may return to the opening screen 812 or Host selection 816, browse the venue food and beverage menu 820, view information about the Host's media queue (if the Host is part of a jukebox network) 822, search for menu items 824, or view and edit the user's lists of menu items or account settings 818. While browsing the menu 820, there may be several categories and sub-categories of menu items 826 as well as individual menu items 832.

For example, an appetizer category may have items listed 826 as cold and hot, and there may be alcoholic and non-alcoholic beverages, but there may only be one category 832 of main course. When browsing the menu 820, 826, 832, or viewing search results 830, if a user chooses an individual menu item 828, in a preferred embodiment the user will see detailed information about the menu item such as a description and ingredients. In a preferred embodiment, yet more information may be available 836 through further interaction, for example, following a link. An example of such additional content may be a preparation or promotional video or a coupon for the item, preferred wine pairings, or other information. A person of skill in the art will appreciate that which information appears at various selection levels may be configurable; for example, an ingredient list or wine pairing may appear in the first level of detail for a menu item 828 or may appear only after user selection of an interactive element 836, depending upon the configuration set by an administrator. In one embodiment of the invention, a user may be able to order menu items for pickup or pre-order 834.

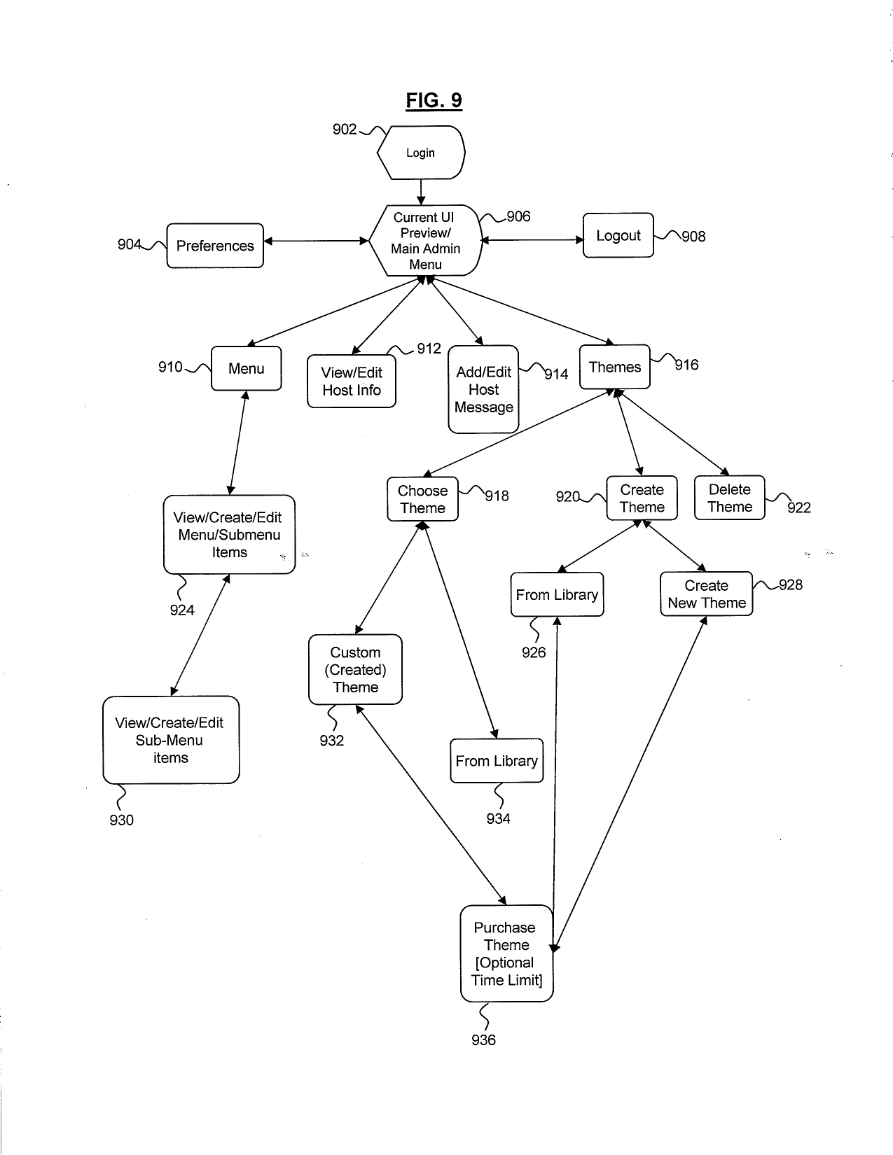

FIG. 9 is a flow chart that depicts an embodiment of the present invention, a method of provisioning, management, and tracking of media selections and information provision. Referring to FIG. 9, an administrative user logs on 902, preferably through a browser although in another embodiment through another client. During an administrative user session the administrative user may have a preview of the current user display options that have been chosen, concurrent with a menu 906. The administrator may logout 908, change user preferences for the administrative account 904, view, create, and edit menu and submenu items 910, 924, 930, view and edit Host information 912 such as name, address or other coordinates, and logo, edit messages such as the daily special 914, and edit the look and feel of the menu application interface seen by users (called a theme) 916. The message may be set 914 manually or by rule; for example, if there are seven daily specials there may be a rule for displaying the message depending on the day of the week. A person of ordinary skill in the art will appreciate that other rules are easily configurable.

An administrator may change many aspects of the wireless device user interface 916, for example, background, header, and button color, font size, style, and color, venue logo, and other cosmetic and functional features. An administrator may also choose 918, 920 a default theme 926, 934, contract for services related to creating a custom theme 932 or create their own 928. An administrator may also delete a previously created theme 922. Payment may be required to include a custom theme for a period of time on a sliding scale 936. In a preferred embodiment, an administrator may have the ability to make changes to the user interface and menu for more than one Host site at a time through access permissions.

In order to access the SaaS server a user associated with the Host such as a venue manager or a remote administrator—for example, a franchise manager, regional manager, or other manager of more than one Host—may access a “Host Dashboard” user interface. In a preferred embodiment, the dashboard may be accessed from a browser or other client on a computer communicatively connected to one or more SaaS servers. The server on which the dashboard interface resides may also contain one or more databases, or it may be communicatively connected to one or more back-end databases.

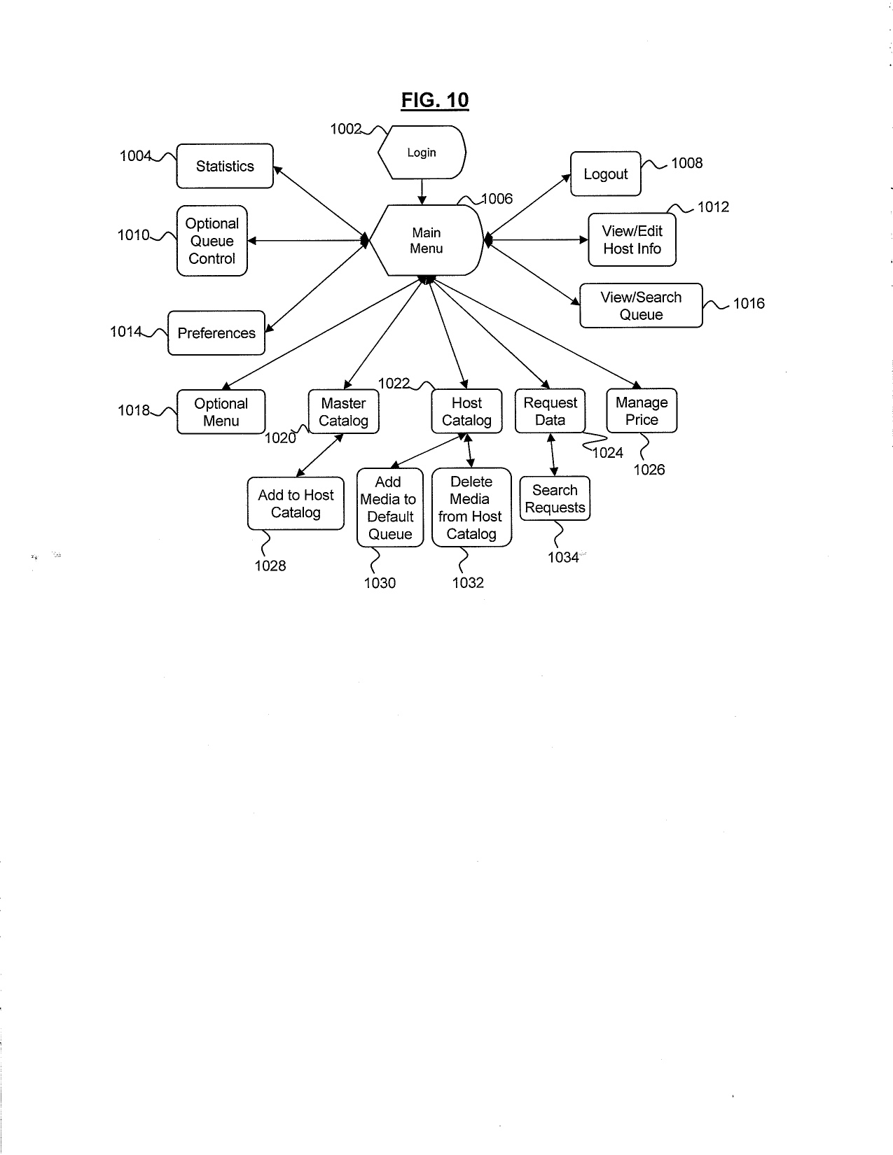

FIG. 10 is a flow chart that depicts an embodiment of the present invention, a method of providing queued content selection and delivery to geographically distributed venues and providing ancillary information and services related to such venues, including a smartphone or wireless device application for ordering and paying for jukebox selections, and a jukebox software service implemented with client-server architecture. A method provides for a user interface to allow provisioning, management, and tracking of media selections and information provision, for example, through a Host Dashboard. Referring to FIG. 10, an administrative user logs on 1002 to a server such as an administrator virtual machine, preferably through a browser although in another embodiment through a proprietary client. An administrative user may have access to information from or control over more than one Host as described above. In a preferred embodiment, if an administrator has access to more than one Host the administrator may see aggregate information such as demographic information 1004 or queue history 1016 from a single Host, a subset of Hosts, or all Hosts.

Demographic 1004, queue 1016, and other information (for example, summary information regarding payments) may be exportable, for example, to CSV, spreadsheet, HTML, or other file formats. In a preferred embodiment, an administrator logs on using a username and password 1002. Access to Hosts, for example, as described above, may be hierarchical, for example, the manager of a venue may have administrative privileges for that Host, a regional manager may have administrative privileges to all of the Hosts in a region, and a national manager to all Hosts nationwide. In one embodiment, administrative privileges may be hierarchical in that access to some features may be restricted for some administrators; for example, a higher level manager may have access to pricing and demographics but another access only to demographics.

In a preferred embodiment, after the administrator logs on using a user name and password 1002 a menu will be shown 1006. In a preferred embodiment the menu will be displayed on a control bar on all or most pages on the administrative interface. For example, upon login the administrator will be shown the menu 1006 and default information available from the application. For example, in a preferred embodiment the first screen displayed to an administrative user after login will contain demographic information 1004 for one or more Hosts as well as instructions for using the administrative application.

Using the administrative application an administrative user with the correct access privileges may do one or more of logout 1008, change user preferences for the administrative account 1014, view demographic information from a demographic database 1004, view and edit Host information such as name, logo, address or other coordinates 1012, view or search the play queue 1016, optionally open an application for controlling the play queue at the Host location or venue 1010, start or stop streaming of the queue, manipulate play order, optionally manage Host participation in the menu application 1018, view a master catalog of media 1020 and add media to the Host catalog from the master catalog 1028, view the Host catalog 1022, delete media from the Host catalog 1032, add media from the Host catalog to a default queue 1030, search the Host or master catalogs, manage the price charged for one or more media items 1026, add credits for media play to customer users, generate codes to be used for media play credits, send invitations to open an account to potential customers with a media play code, and view 1024 or search historical request data 1034.

In one embodiment of the present invention, queue display may contain historical as well as current information such as the unique ID of the queue record, the catalog ID of the media, track name, genre, artist, album, date, status of the selection (such as in the queue, currently playing, played, or cancelled), method of ordering (played from the default queue, from an Internet browser or other client, iPhone application, Blackberry application, Android application, or other wireless device application), or other information regarding the queue for one or more Hosts. In a preferred embodiment the queue will display one day's worth of data. In a preferred embodiment the day shown in the queue display will default to the current date and time, but other days may be selected. In one embodiment multiple days' data may be displayed. In a preferred embodiment the queue display can be restricted or searched by one or more of unique ID or unique ID range, keyword (e.g. track name, user name, user email address, Host name, order method, Host or user zip code, or other textual information), date or date range, status, application type, or other information.

In one embodiment of the present invention a display of request data may include data regarding user requests such as unique ID, user name, one or more items of demographic information about the user, whether the request was successfully added to the Host queue, the number of media items requested, the amount paid for the items in the request, and the date and/or time the request was made. In a preferred embodiment the request display can be restricted or searched by one or more of unique ID or unique ID range, keyword (e.g. user name, user email address, Host name, order method, Host or user zip code, user age or gender, or other textual or demographic information), date or date range, status, or other information.

Each of the method steps shown in the Figures and described herein may be implemented as a software program that includes program instructions. The program instructions may be executed by a processor, microcontroller, digital signal processor or other device capable of executing program instructions as part of the method. The processor and all or portions of the software may reside on a server, a computer, a mobile device such as a smartphone, or any other device capable of executing program instructions and communicating over a network. The software may be stored and executed at a central location, such as a server, or may be stored and executed in a distributed manner at multiple servers and/or at multiple other devices. The software may be, for example, run on a server and interactions by subscriber devices may be via a web browser that interacts with the server. Alternatively, portions of the software may be made available to subscriber devices by a plug-in to a web browser. In still other embodiments, portions of the software may be embodied in application programs that run on subscriber devices and devices at the venue that in turn interact with the server and database.

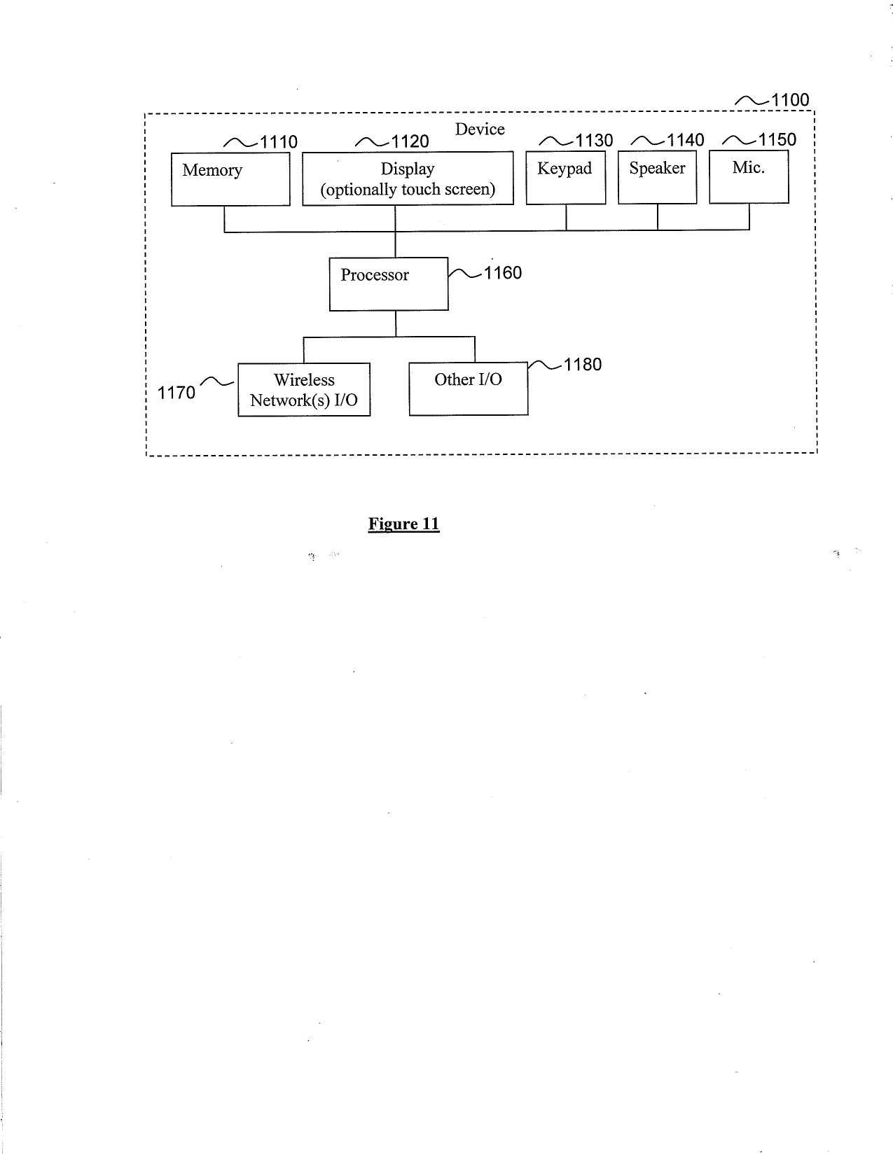

Each of the software programs described herein may be stored in a computer usable medium, such as a memory, a hard disk drive, a solid-state memory or drive, a CD ROM or DVD or on a database or any other type of memory including memory accessible over a network. For example, the illustrative device 1100 shown in FIG. 11 may be used to store the such programs in the memory 1110, which may include any of the previously mentioned types of memory. During use, the software may be loaded into the memory of a general purpose computer or other device 1100 that includes, for example, a processor 1160 (or microcontroller, digital signal process or other device that executes instructions) coupled to a memory 1110, a display 1120, which may be a regular or touch screen type display, a keypad or keyboard 1130, a speaker 1140, a microphone 1150, a wireless or other network i/o unit 1170 for connecting electrically, optically or wirelessly to the Internet or other network, other i/o interfaces 1180, such as a universal serial bus (USB) interface, firewire interface or other i/o interface, and any additional input/output devices such as a mouse. The software programs include program instructions and data that when loaded in the memory are accessed, executed and used by the processor to carry out described method steps described herein, including allowing data and control inputs from users or the network connection, and creating and displaying output. The input from the user may be made via any input, including the display, keypad, microphone or other input device.

While particular embodiments of the present invention have been shown and described, it will be understood by those having ordinary skill in the art that changes may be made to those embodiments without departing from the spirit and scope of the present invention.

1. A method of providing content delivery, comprising:
providing a database of content, accessible via a network;
allowing selection of content by a device on the network,
determining a venue where the content should be delivered, and
providing an indication that the selected content is in a queue to be presented at the venue.

2. The method according to claim 1, wherein the queue is provided to the device for display to the user of the device.

3. The method according to claim 1, wherein the queue is provided to a plurality of additional devices of users that are present at the venue.

4. The method according to claim 1, wherein the queue is provided to a plurality of additional devices of users that specify the venue.

5. The method according to claim 1, wherein a plurality of additional venues are available for selection.

6. The method according to claim 1, wherein the queued content for presentation at the venue is played at the venue in the order of the queue.

7. The method according to claim 6, wherein playing comprises streaming the content to a host at the venue.

8. The method according to claim 6, wherein playing comprises transmitting content as a download to a host at the venue.

9. The method according to claim 8, wherein the downloaded content is protected by DRM with an expiration time.

10. The method according to claim 1, wherein determining a venue further comprises searching a database of venues for criteria selected by a user.

11. The method according to claim 10, wherein determining a venue further comprises providing for selection a plurality of venues with the criteria.

12. A method of providing user selectable content for a venue, comprising:
receiving, at a mobile device, a list of content available from a content subscription server for playing;
selecting content from the list;
assigning a venue to the selection;
transmitting the selection and venue to the content subscription server; and
receiving a queue for the venue, the queue including selections queued for playing at the venue.

13. The method according to claim 12, wherein the mobile device of the user prompts the user for payment for playing the selection at the venue and the user effectuates payment using the device.

14. The method according to claim 13, wherein the selection from the user is placed into the queue for the venue after payment is made.

15. The method according to claim 14, wherein the payment is in the amount of a highest bid made in an auction.

16. The method of claim 12, further comprising:
receiving a menu for the venue.

17. The method of claim 16, wherein the menu is an hypertext markup language file that allows the user to obtain menu information and other information about the selected venue.

18. A method of delivering user requested content at a venue, comprising:
receiving at a computer coupled to a network user selected content in a queue;
playing the content from the queue over an audio system in the venue;
wherein the queue is created by a remote content subscription server and the contents of the queue embody selections by different mobile devices associated with the venue by users of those devices.

19. The method of claim 18, wherein content is only placed into the queue after users of the mobile devices have selected the content and made electronic payment for the selected content using the mobile devices.

20. The method according to claim 19, wherein a plurality of mobile devices at each venue may be used to alter the queue.

21-41. (canceled)
